(19) United States
(12) Patent Application Publication
(10) Pub. No.: US 2014/0191541 A1
(43) Pub. Date: Jul. 10, 2014

(54) BED COMBINATION METHOD, BED SEPARATION METHOD AND BED

(71) Applicant: PANASONIC CORPORATION, Osaka (JP)

(72) Inventors: Akihiro Ohta, Osaka (JP); Yohei Kume, Osaka (JP); Shohei Tsukada, Hyogo (JP); Tohru Nakamura, Osaka (JP); Hideo Kawakami, Osaka (JP); Tomohiro Shimoda, Osaka (JP); Masaya Miyamoto, Osaka (JP)

(21) Appl. No.: 14/240,812

(22) PCT Filed: Sep. 12, 2012
(86) PCT No.: PCT/JP2012/005788

§ 371 Date: Feb. 25, 2014

(30) Foreign Application Priority Data
Sep. 22, 2011 (JP) 2011-206932

(51) Int. Cl. A61G 7/16

(52) U.S. Cl. CPC A61G 7/16
USPC 297/118; 29/428; 29/426.1

(57) ABSTRACT

In a bed combination method of forming a bed on which a person lies by combining a wheelchair with a recess part of a bed base portion of a bed main portion, a posture of a seat portion of the wheelchair is changed from a chair posture to a tilt posture where the seat portion is inclined in such a manner that a position of a footrest is higher than the base portion by a tilt action while a shape of the seat portion is maintained as a chair shape, and then, the wheelchair is moved to the recess part of the base portion, and the seat portion is changed from the tilt posture to a non-tilt posture.

### TECHNICAL FIELD

The present invention relates to a combination method of a bed whose part is separable as a wheelchair, a separation method, and a bed.

### BACKGROUND ART

In nursing care to a bedridden aged person or an ailing person, transferring a care-receiver lying on a bed from the bed to a wheelchair requires a caregiver of a lot of labor. A bed which saves the caregiver the labor of the transferring task by making the wheelchair a part of the bed is proposed (for example, refer to Patent Literature 1).

Such a bed is composed of a bed main portion and a wheelchair. In a case where the bed is utilized as a bed on which the care-receiver lies, the wheelchair is combined with the bed main portion, and a seat portion of the wheelchair is brought into a flat posture. In a case where the bed is utilized only as a wheelchair, the wheelchair is separated from the bed main portion, and the seat portion of the wheelchair is brought into a chair posture. The “chair posture” is a posture where a chair back bottom member of the seat portion is substantially vertically raised and a chair leg bottom member is substantially vertically lowered.

FIG. 20 is a view showing a conventional bed 1 in a combining preparation state.

In order to combine a wheelchair 3 with a bed main portion 2 so as to compose the bed 1 on which a person lies, firstly, as shown in FIG. 20, the wheelchair 3 is brought into a leg lifting posture from the chair posture.

The “leg lifting posture” is a posture of a seat portion 4 where a chair leg bottom member 5 is moved to a position higher than a base portion 6 of the bed main portion 2 in such a manner that the chair leg bottom member 5 serving as a part of the seat portion 4 of the wheelchair 3 does not collide with the base portion 6. It should be noted that by drive of the chair leg bottom member 5, the seat portion 4 is brought into the leg lifting posture.

The wheelchair 3 is moved from the side of the bed main portion 2 toward a storage region 7 serving as a recess of the base portion 6 in a state where the seat portion 4 is in the leg lifting posture, and stopped at a position where the wheelchair enters the storage region 7. A chair back bottom member and the chair leg bottom member 5 are driven and a posture of the seat portion 4 is changed from the leg lifting posture to a flat posture. The “flat posture” is a posture where members composing the seat portion 4 are positioned substantially on one plane and the seat portion 4 is parallel to a floor surface on which the bed 1 is mounted. In such a way, the wheelchair 3 is combined with the bed main portion 2 so as to compose the bed 1.

By using such a bed, the caregiver and the like can let the care-receiver lie on the bed 1 from the wheelchair 3 without taking up and transferring the care-receiver from the wheelchair 3. Therefore, the use of such a bed 1 can save the caregiver the labor of the transferring task.

### CITATION LIST

### Patent Literature

Patent Literature 1: International Publication No. 2010/113413

### SUMMARY OF INVENTION

### Technical Problem

However, with the conventional bed combination method described above, the posture of the wheelchair 3 is changed from the chair posture to the flat posture through the leg lifting posture at the time of combination actions. At this time, in the leg lifting posture, a body posture of the care-receiver becomes a leg lifting body posture where toes are placed at a position higher than a hip part. However, this leg lifting body posture may sometimes impose a burden on a body of the care-receiver. Along with a posture change of the seat portion 4, as in a change from a seating body posture (body posture of the care-receiver when the care-receiver is seated in the wheelchair in the chair posture) to the leg lifting body posture, and a change from the leg lifting body posture to an upward facing body posture (body posture of the care-receiver when the care-receiver extends the whole body on the wheelchair in the flat posture at the time of lying on the bed), the body posture of the care-receiver is changed as many as twice. Thus, the burden may be imposed on the body of the care-receiver.

An object of the present invention is to provide a bed, a combination method, and a separation method thereof, each of which is capable of reducing the burden on the body of the care-receiver at the time of actions of combining with the bed and actions of separating from the bed.

### Solution to Problem

In order to achieve the above object, a bed combination method according to one aspect of the present invention is a bed combination method of combining a chair base portion of a wheelchair with a bed base portion of a bed main portion so as to form a bed,

the method comprising:

at a combining preparation position in a vicinity of the bed base portion of the bed main portion, causing a seat portion of the wheelchair to perform a tilt action with respect to the chair base portion in a state where the seat portion is in a chair posture with respect to the chair base portion, and changing a posture of the seat portion to a tilt posture where the seat portion is inclined in such a manner that a position of a footrest composing the seat portion of the wheelchair is higher than the bed base portion of the bed main portion.

In order to achieve the above object, a bed separation method of separating a wheelchair from a bed formed by combining a chair base portion of the wheelchair with a recess part of a bed base portion of a bed main portion,

the method comprising:

changing a posture of a seat portion of the wheelchair stored in the recess part of the bed base portion of the bed main portion from a flat posture and a non-tilt posture to a tilt posture where a position of a footrest is higher than the bed base portion in a state of a chair posture.

In order to achieve the above object, a bed according to still another aspect of the present invention is a bed characterized by including a control section that performs the bed combination method of the above aspect or/and the bed separation method of the above aspect.

### Advantageous Effects of Invention

The aspects of the present invention can provide the bed capable of reducing the burden on the body of the care-receiver at the time of the actions of combining with the bed and the actions of separating from the bed, and the combination method or the separation method thereof.

### BRIEF DESCRIPTION OF DRAWINGS

These and other objects and features of the present invention will become clear from the following description taken in conjunction with the preferable embodiments thereof with reference to the accompanying drawings, in which:

FIG. 1A is a perspective view of a bed in a separated state according to a first embodiment of the present invention;

FIG. 1B is a block diagram showing a configuration of a control section, a drive unit, and the like of the bed according to the first embodiment;

FIG. 2 is a flowchart showing a combination method of the bed according to the first embodiment;

FIG. 3A is a perspective view showing a wheelchair in a chair posture according to the first embodiment;

FIG. 3B is a perspective view showing the wheelchair in a tilt posture according to the first embodiment;

FIG. 3C is a perspective view showing the wheelchair in a flat posture according to the first embodiment;

FIG. 4A is a schematic side view showing the wheelchair in the chair posture according to the first embodiment;

FIG. 4B is a side view of a seat guide mechanism unit of the wheelchair;

FIG. 4C is a schematic side view showing the wheelchair in the tilt posture;

FIG. 5 is a perspective view of the bed in a combining preparation state according to the first embodiment;

FIG. 6 is a schematic side view of the wheelchair in the combining preparation state according to the first embodiment;

FIG. 7 is a perspective view of the bed in a state where the wheelchair according to the first embodiment is moved into a storage region;

FIG. 8 is a schematic side view of the bed in a state where the wheelchair according to the first embodiment is moved into the storage region;

FIG. 9 is a schematic side view of the bed showing the middle of a posture change of the wheelchair according to the first embodiment from the tilt posture to the flat posture;

FIG. 10 is a schematic side view of the bed in a combining completion state according to the first embodiment;

FIG. 11 is a perspective view of the bed in the combining completion state according to the first embodiment;

FIG. 12 is a flowchart of detailed steps of bed formation step S05 of FIG. 2 according to the first embodiment;

FIG. 13A is a side view of the bed including the wheelchair in the tilt posture and the chair posture, for illustrating the detailed steps of bed formation step S05 of FIG. 2 according to the first embodiment;

FIG. 13B is a side view of the bed including the wheelchair in a state where a reclining angle θr is a reclining angle θr0 in the “tilt posture”, for illustrating the detailed steps of bed formation step S05 of FIG. 2 according to the first embodiment;

FIG. 13C is a side view of the bed according to a comparative example;

FIG. 13D is a side view of the bed for illustrating the detailed steps of bed formation step S05 of FIG. 2 according to the first embodiment;

FIG. 13E is a side view of the bed including the wheelchair in a non-tilt posture and the flat posture, for illustrating the detailed steps of bed formation step S05 of FIG. 2 according to the first embodiment;

FIG. 14 is a perspective view of the bed in a state where back lifting and knee lifting are performed according to the first embodiment;

FIG. 15 is a flowchart showing a separation method of the bed according to the first embodiment;

FIG. 16 is a flowchart of detailed steps of separating preparation step S11 of FIG. 15 according to the first embodiment;

FIG. 17 is a schematic side view of the bed showing the middle of a posture change of the wheelchair according to a second embodiment of the present invention from the non-tilt posture to the tilt posture;

FIG. 18 is a schematic side view of the bed in a separating preparation state of the wheelchair according to the second embodiment of the present invention;

FIG. 19 is a schematic side view of the bed showing the middle of a posture change of the wheelchair according to the second embodiment of the present invention from the tilt posture to the chair posture; and

FIG. 20 is a view showing a conventional bed in a combining preparation state.

### DESCRIPTION OF EMBODIMENTS

Hereinafter, a first embodiment in the present invention will be described in detail with reference to the drawings.

Hereinafter, embodiments of the present invention will be described with reference to the drawings. It should be noted that the same constituent elements will be given the same reference signs, and description thereof will sometimes be omitted. For easy understanding, the drawings are schematic focusing on the constituent elements. It should be noted that in the following description, a “posture” and a “body posture” are distinguished from each other to be used in a case where a shape of a seat portion of a wheelchair is described and in a case where a bending shape of a body of a care-receiver is described, respectively.

In the following description, a “flat posture” is a posture where members composing the seat portion of the wheelchair are substantially positioned on one plane. A “chair posture” is a posture where a chair back bottom member of the seat portion of the wheelchair is lifted substantially vertically with respect to a chair waist bottom member and a chair leg bottom member is lowered substantially vertically with respect to the chair waist bottom member. A “leg lifting posture” is a posture where the chair leg bottom member is moved to a position higher than a base portion of a bed main portion in such a manner that the chair leg bottom member serving as a part of the seat portion of the wheelchair does not collide with the base portion of the bed main portion.

A “tilt action” is an action of the seat portion while divided members of the seat portion of the wheelchair are maintained in substantially the same angle relationship as that in the chair posture. That is, the “tilt action” is an action of changing angles of the entire seat portion while maintaining an angle relationship between the chair waist bottom member and the chair back bottom member of the seat portion of the wheelchair. Therefore, depending on a structure of the wheelchair, the tilt action can be performed while in the flat posture or the tilt action can also be performed while in the chair posture. It should be noted that in the following description, a posture in a state where the tilt action is performed while in the chair posture, that is, a posture where the chair waist bottom member is inclined by the tilt action while in the chair posture is a “tilt posture”.

In the following description, a “seating body posture” is a body posture of the care-receiver when the care-receiver is seated in the wheelchair in the chair posture. An “upward facing body posture” is a body posture of the care-receiver when the care-receiver lies on the wheelchair in the flat posture, the body posture where the care-receiver extends the whole body.

### First Embodiment

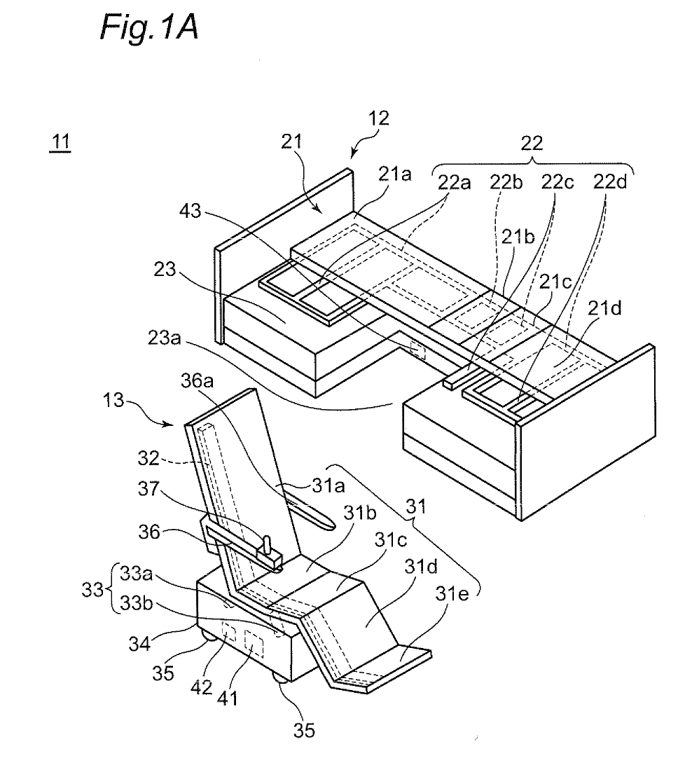

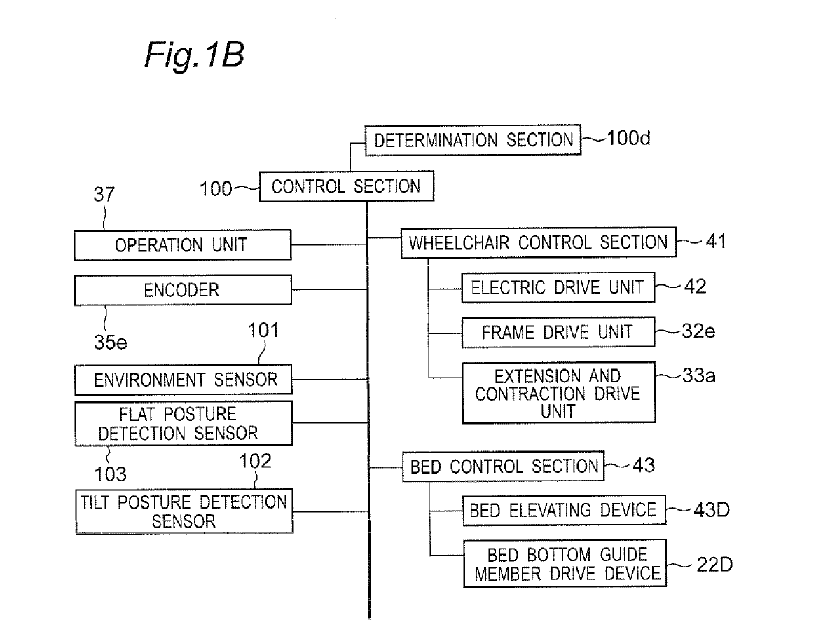

FIGS. 1A, 1B, 2, 3A, 3B, 3C, 4A, and 4B are figures for illustrating a bed combination method according to the first embodiment of the present invention.

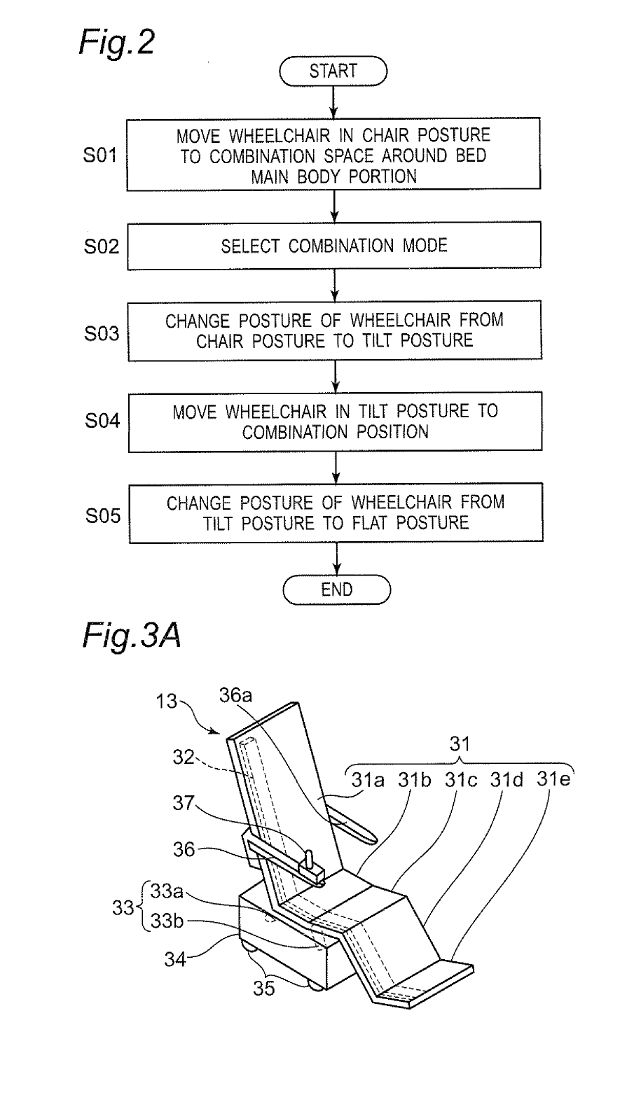

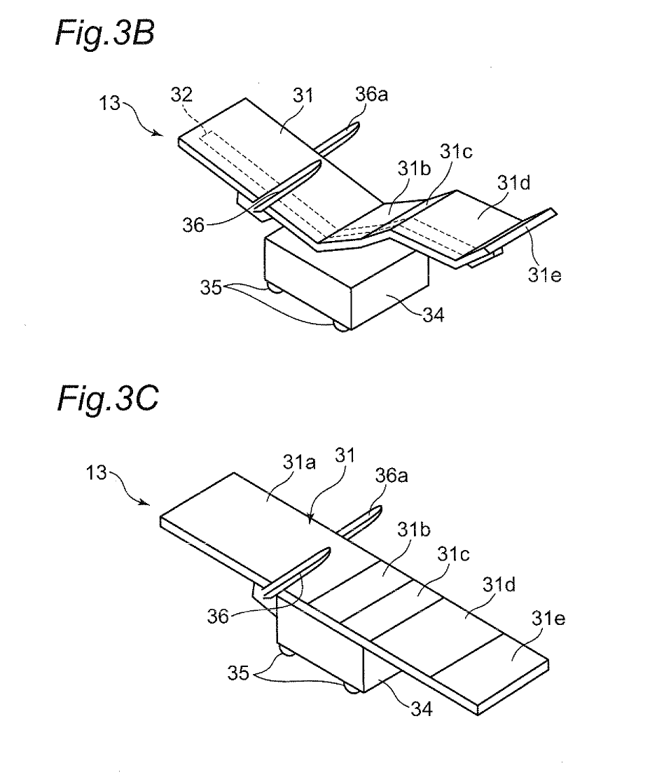

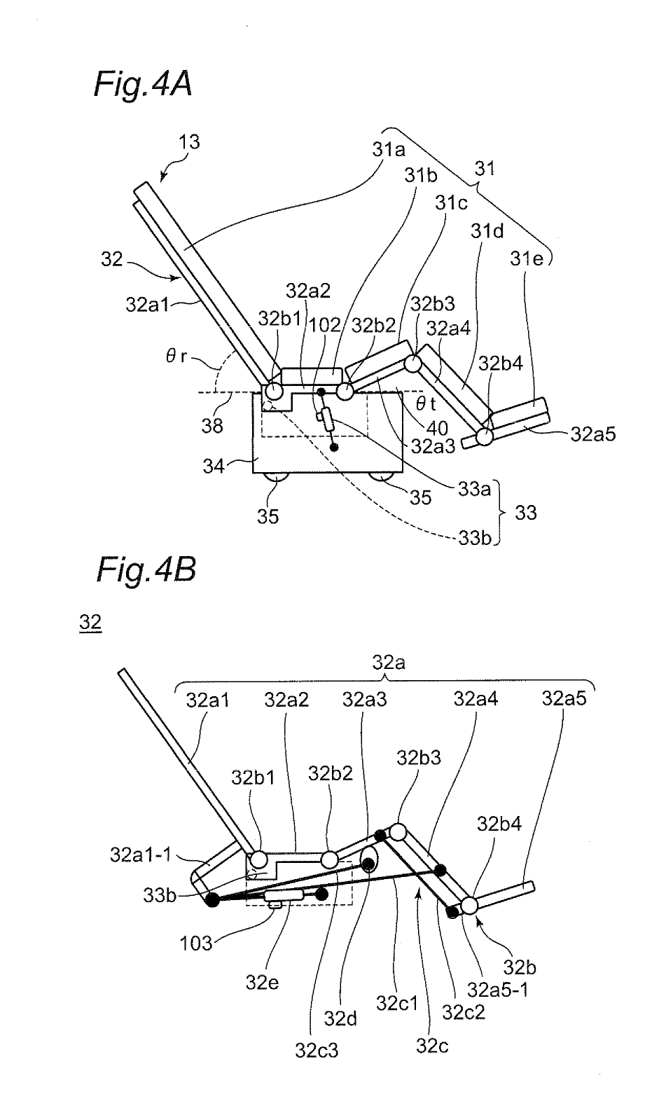

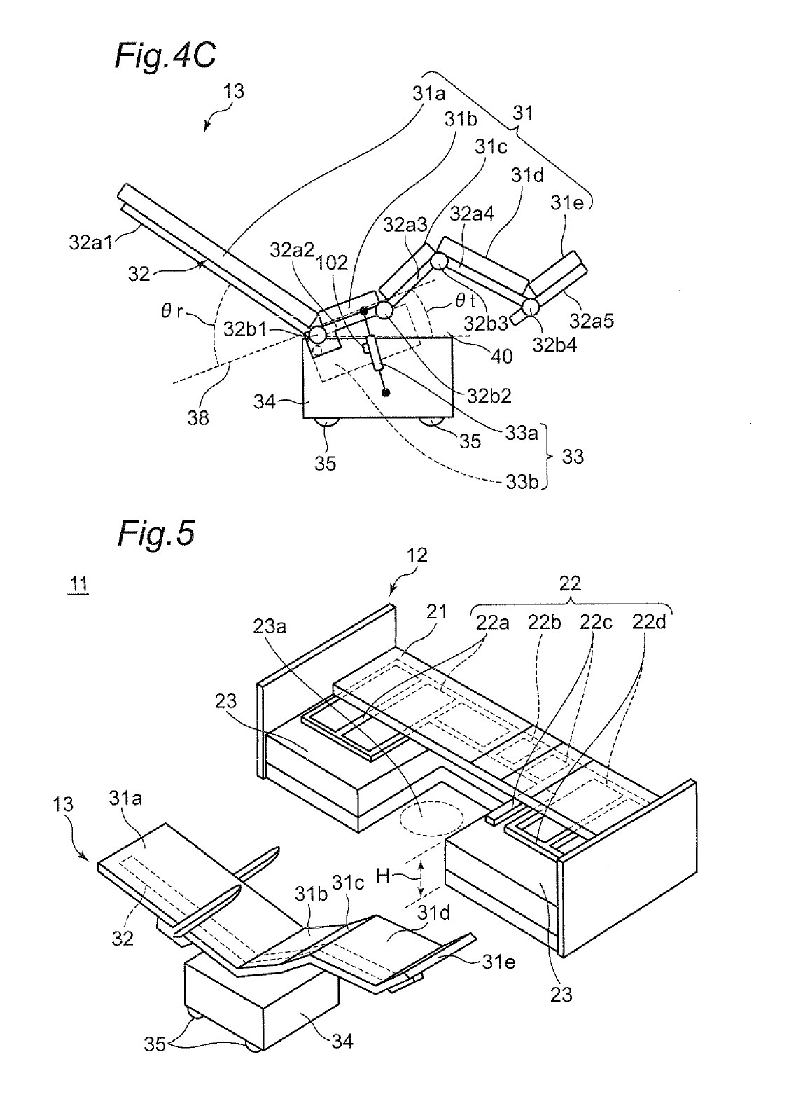

FIG. 1A is a perspective view of a bed 11 in a separated state according to the first embodiment. FIG. 1B is a block diagram showing a configuration of a control section 100, a drive unit, and the like of the bed 11 according to the first embodiment. Since the bed 11 in the separated state is shown in FIG. 1A, a bed main portion 12 and a wheelchair 13 in the chair posture are shown. FIG. 2 is a flowchart showing the combination method of the bed 11 according to the first embodiment. FIG. 3A is a perspective view showing a wheelchair 13 in the chair posture according to the first embodiment. FIG. 33 is a perspective view showing the wheelchair 13 in a state where the tilt action is performed while in the chair posture according to the first embodiment. It should be noted that FIG. 33 also serves as a perspective view showing the wheelchair 13 in the tilt posture. FIG. 3C is a perspective view showing the wheelchair 13 in the flat posture according to the first embodiment. FIGS. 4A and 48 are views for illustrating a mechanism of the wheelchair according to the first embodiment. FIG. 4A is a schematic side view. FIG. 48 is a side view of a seat guide mechanism unit 32 of the wheelchair 13.

A seat portion 31 of the wheelchair 13 has a plurality of divided members, and the adjacent members are respectively rotatably coupled to each other. The plurality of divided members is composed of at least a chair back bottom member 31a, a chair waist bottom member 31b, and a first chair leg bottom member 31d. It should be noted that the plurality of divided members may include a chair knee bottom member 31c and a second chair leg bottom member 31e. The chair back bottom member 31a is a part of the seat portion 31 to be brought into contact with a back of the care-receiver. The chair waist bottom member 31b is a part of the seat portion 31 to be brought into contact with a waist of the care-receiver. The chair knee bottom member 31c is a part of the seat portion 31 to be brought into contact with thighs of the care-receiver. The first chair leg bottom member 31d is a part of the seat portion to be brought into contact with legs of the care-receiver. The second chair leg bottom member 31e is a part of the seat portion 31 to be brought into contact with heels of the care-receiver. A coupling portion of coupling the chair back bottom member 31a and the chair waist bottom member 31b is a part corresponding to a waist joint of the care-receiver sitting in the wheelchair 13. A coupling portion of coupling the chair waist bottom member 31b and the chair knee bottom member 31c is a part corresponding to a hip joint of the care-receiver. A coupling portion of coupling the chair knee bottom member 31c and the first chair leg bottom member 31d is a part corresponding to knee joints of the care-receiver. A coupling portion of coupling the first chair leg bottom member 31d and the second chair leg bottom member 31e is a part corresponding to ankle joints of the care-receiver. These members normally have a cushion function.

It should be noted that the seat portion 31 is supported by frame members 32a of the seat guide mechanism unit 32. An angle relationship among the plurality of divided members of the seat portion 31 is substantially the same as an angle relationship among the frame members 32a of the seat guide mechanism unit 32. Specifically, angles of the chair back bottom member 31a of the seat portion 31 are substantially the same as angles of a chair back frame member 32a1. Angles of the chair waist bottom member 31b are substantially the same as angles of a chair waist frame member 32a2. Angles of the chair knee bottom member 31c are substantially the same as angles of a chair knee frame member 32a3. Angles of the first chair leg bottom member 31d are substantially the same as angles of a first chair leg frame member 32a4. Angles of the second chair leg bottom member 31e are substantially the same as angles of a second chair leg frame member 32a5.

The angle relationship among the frame members 32a of the seat guide mechanism unit 32 of the wheelchair 13 in the chair posture shown in FIG. 3A are defined as a “chair angle”. The angle relationship among the frame members 32a of the seat guide mechanism unit 32 of the wheelchair 13 in the flat posture shown in FIG. 3C is defined as a “bed angle”.

As shown in FIG. 1A, the bed 11 is composed by combining the bed main portion 12 and the wheelchair 13. This bed 11 functions as an electric nursing care bed by changing a posture of the entire bed 11 by a bed control section 43 incorporated in a lower part of the bed 11. The wheelchair 13 separated from the bed main portion 12 is an electric wheelchair movable following a manipulation of the care-receiver. As described later, this wheelchair 13 is utilized by the passenger care-receiver as an omnidirectional movement type electric wheelchair provided with omnidirectional movement wheels 35, the electric wheelchair being capable of being moved in all directions. One example of the omnidirectional movement wheels 35 is omni wheels or Mecanum wheels.

The bed main portion 12 has a half bed bottom portion 21, a bed bottom guide member 22, a base portion (bed base portion) 23, and the bed control section 43. The half bed bottom portion 21 is composed by rotatably coupling adjacent divided members to each other. The divided members have a width which is about a substantial half of width of the entire bed bottom portion 39 of the bed 11 (refer to FIG. 11). Specifically, in the first embodiment, the half bed bottom portion 21 is composed by coupling, in series, four divided members (a bed back bottom member 21a, a bed waist bottom member 21b, a bed knee bottom member 21c, and a bed leg bottom member 21d) having a width which is about a substantial half of the width of the entire bed bottom portion 39 of the bed 11. The bed back bottom member 21a is a part of the half bed bottom portion 21 to be brought into contact with the back of the care-receiver. The bed waist bottom member 21b is a part of the half bed bottom portion 21 to be brought into contact with the waist of the care-receiver. The bed knee bottom member 21c is a part of the half bed bottom portion 21 to be brought into contact with the thighs of the care-receiver. The bed leg bottom member 21d is a part of the half bed bottom portion 21 to be brought into contact with the legs and the heels of the care-receiver. The bed back bottom member 21a, the bed waist bottom member 21b, the bed knee bottom member 21c, and the bed leg bottom member 21d normally have a cushion function. A coupling portion of the bed back bottom member 21a and the bed waist bottom member 21b is a part corresponding to the waist joint of the care-receiver. A coupling portion of the bed waist bottom member 21b and the bed knee bottom member 21c is a part corresponding to the hip joint of the care-receiver. A coupling portion of the bed knee bottom member 21c and the bed leg bottom member 21d is a part corresponding to the knee joints of the care-receiver. The bed back bottom member 21a, the bed waist bottom member 21b, the bed knee bottom member 21c, and the bed leg bottom member 21d are rotatably coupled to each other by the coupling portions.

The bed bottom guide member 22 is quadrilateral frame shape members respectively having a width which exceeds a substantial half of width of the bed 11 (for example, about three fourth of the width of the bed 11). Specifically, in the first embodiment, the bed bottom guide member 22 is composed by coupling four quadrilateral frame shape divided members (a bed back guide member 22a, a bed waist guide member 22b, a bed knee guide member 22c, and a bed leg guide member 22d) in series, and respectively supports the four divided members (the bed back bottom member 21a, the bed waist bottom member 21b, the bed knee bottom member 21c, and the bed leg bottom member 21d) of the half bed bottom portion 21. Further, in the bed bottom guide member 22, the adjacent divided members among the four divided members (the bed back guide member 22a, the bed waist guide member 22b, the bed knee guide member 22c, and the bed leg guide member 22d) are rotatably coupled to each other. A coupling portion of the bed back guide member 22a and the bed waist guide member 22b is a part corresponding to the waist joint of the care-receiver. A coupling portion of the bed waist guide member 22b and the bed knee guide member 22c is a part corresponding to the hip joint of the care-receiver. A coupling portion of the bed knee guide member 22c and the bed leg guide member 22d is a part corresponding to the knee joints of the care-receiver. The bed waist guide member 22b of the bed bottom guide member 22 is fixed to the base portion 23. When rotation axes of the coupling portions of the half bed bottom portion 21 and rotation axes of the coupling portions of the bed bottom guide member 22 are the same axes, the bed bottom guide member 22 can support the half bed bottom portion 21 and the bed bottom portion 39 in various postures. The bed bottom guide member 22 can variously change postures of the half bed bottom portion 21 and the bed bottom portion 39 including the half bed bottom portion 21 (refer to FIG. 11) by driving and rotating the bed back guide member 22a, the bed waist guide member 22b, the bed knee guide member 22c, and the bed leg guide member 22d.

The base portion 23 can be lifted and lowered so as to change the height of the base portion itself, and supports the bed bottom guide member 22 from the lower side. A storage region 23a serving as a recess part is formed in one side part of the base portion 23. The storage region 23a formed in the one side part of the base portion 23 is a space into and from which a chair base portion 34 is capable of moving in and out. A width of the storage region 23a is a substantial half of the width of the bed 11.

The bed control section 43 drives and controls a bed elevating device 43D (refer to FIG. 1B) so as to elevate the base portion 23 of the bed main portion 12. At the time of bed combination (when the wheelchair 13 is combined with the bed main portion 12), by driving the bed elevating device 43D so as to lift up the base portion 23 of the bed main portion 12, the bed control section 43 brings the bed bottom guide member 22 of the bed main portion 12 in contact with the seat portion 31 of the wheelchair 13 so as to match a height between the half bed bottom portion 21 of the bed main portion 12 and the seat portion 31 of the wheelchair 13. By driving and controlling a bed bottom guide member drive device 22D, the bed control section 43 brings up parts of the half bed bottom portion 21 and the seat portion 31 around a back surface and the knees of the care-receiver by the bed bottom guide member 22, so that the posture can be a back lifting posture and a knee lifting posture. By driving and controlling the bed bottom guide member drive device 22D, the bed control section 43 can change the postures of the half bed bottom portion 21 and the seat portion 31 to the flat posture.

As shown in FIGS. 1A and 4A, the wheelchair 13 has the seat portion 31, the seat guide mechanism unit 32, a seat inclination mechanism unit 33, the chair base portion 34, a wheelchair control section 41, an electric drive unit 42, the omnidirectional movement wheels 35, a pair of armrests 36, 36a, and an operation unit 37.

As described above, the seat portion 31 is composed of the plurality of divided members, and the adjacent divided members are rotatably coupled to each other. It should be noted that the second chair leg bottom member 31e among the divided members serves as a footrest for the care-receiver when the wheelchair 13 is in the chair posture.

The seat guide mechanism unit 32 is composed of the frame members 32a (the chair back frame member 32a1, the chair waist frame member 32a2, the chair knee frame member 32a3, the first chair leg frame member 32a4, and the second chair leg frame member 32a5), and respectively supports the seat portion 31 (the chair back bottom member 31a, the chair waist bottom member 31b, the chair knee bottom member 31c, the first chair leg bottom member 31d, and the second chair leg bottom member 31e). Details will be described later.

The seat inclination mechanism unit 33 supports the seat guide mechanism unit 32 and rotates the seat guide mechanism unit 32. A detailed structure will be described later.

The chair base portion 34 has a width which is a substantial half of the width of the bed 11, and supports the seat inclination mechanism unit 33.

The wheelchair control section 41 is incorporated in the chair base portion 34. Although appropriately omitted in the following description, actions of the wheelchair 13 are controlled by this wheelchair control section 41. The actions of the wheelchair 13 include for example, posture changes of the seat guide mechanism unit 32 by drive of a frame drive unit 32e and of the seat inclination mechanism unit 33 by drive of an extension and contraction drive unit 33a, and drive of the omnidirectional movement wheels 35 by drive of the electric drive unit 42.

The electric drive unit 42 is provided in the chair base portion 34 in a lower part.

Four omnidirectional movement wheels 35 in total are arranged in both side parts on the lower side of the chair base portion 34 so as to be rotatable forward and backward, and driven by the electric drive unit 42.

The pair of armrests 36, 36a is fixed to the chair back bottom member 31a rotatably within a predetermined angle range. It should be noted that in the first embodiment, the armrests 36, 36a are retained rotatably in an angle range from an angle with which the longitudinal direction thereof is parallel to the longitudinal direction of the chair back bottom member 31a to an angle with which the armrests are parallel to a floor surface when the chair back bottom member 31a is in a chair shape. The left armrest 36a can be driven and rotated so as to be accommodated in a back surface of the chair back bottom member 31a.

The operation unit 37 is provided in at least one side armrest (as one example, in FIG. 1A, the right armrest) 36. The operation unit 37 is composed of a mode selection button for selecting a manipulation mode, a mode display portion for visibly displaying the selected mode, and a joystick for inputting the action direction or an action amount. The mode to be selectable by the mode selection button includes a “movement mode” in which the wheelchair 13 is moved by a manipulation in the operation unit 37, a “combination mode” in which the wheelchair 13 is combined with the bed main portion 12, a “separation mode” in which the wheelchair 13 is separated from the bed main portion 12, a “reclining change mode” in which the posture of the seat portion 31 of the wheelchair 13 is changed, and a “tilt change mode” in which a tilt angle of the wheelchair 13 to be described later is changed. When the reclining change mode is selected by the manipulation of the mode selection button of the operation unit 37, the wheelchair 13 drives the seat guide mechanism unit 32 in accordance with an input of the joystick of the operation unit 37, so as to perform a reclining action. The reclining action is an action of changing a reclining angle of the seat portion 31, that is, the action in which the chair back frame member 32a1, the first chair leg bottom member 31d, and the second chair leg bottom member 31e are moved in conjunction. Specifically, when the joystick of the operation unit 37 is inclined forward, the wheelchair 13 changes the reclining angle of the seat portion 31 in the direction in which a head is lifted at fixed speed (in the direction in which a reclining angle θr is increased). Conversely, when the joystick of the operation unit 37 is inclined rearward, the wheelchair 13 changes the reclining angle of the seat portion 31 in the direction in which the head is lowered at fixed speed (in the direction in which the reclining angle θr is decreased). When the joystick of the operation unit 37 is returned to a neutral position, an angle change of the seat portion 31 is stopped. It should be noted that upon inputs in the left and right direction of the joystick of the operation unit 37, no reclining action is performed.

The reclining action serving as a posture change of the seat portion 31 is performed by an action of the seat guide mechanism unit 32. As shown in FIG. 4A and the like, the angle θr made by a seat (surface) of the chair back bottom member 31a and an extension line 38 of a seat (surface) of the chair waist bottom member 31b is called as the “reclining angle”. For example, when the posture of the seat portion 31 is the flat posture, the reclining angle θr is 0°.

With using FIG. 4B, the seat guide mechanism unit 32 will be described. As shown in FIG. 4B, the seat guide mechanism unit 32 has the plurality of frame members 32a (the frame member 32a1, the frame member 32a2, the chair knee frame member 32a3, the first chair leg frame member 32a4, and the second chair leg frame member 32a5) supporting the seat portion 31, a plurality of joint portions 32b (32b1, 32b2, 32b3, 32b4) pivotably supporting the respective frame members 32a, coupling links 32c (a first coupling link 32c1, a second coupling link 32c2, and a third coupling link 32c3), a coupling cam 32d, and the frame drive unit 32e serving as power for moving the frame members 32a.

The rod shape first coupling link 32c1 couples a front end of an L shape back side arm member 32a1-1 in a back surface lower part of the frame member 32a1 and an intermediate part of the first chair leg frame member 32a4. The rod shape second coupling link 32c2 couples a part of the chair knee frame member 32a3 in the vicinity of the side of the joint portion 32b3 and a protruding portion 32a5-1 of the second chair leg frame member 32a5 protruding to the back surface side from the side of the joint portion 32b4.

The coupling cam 32d is rotatably arranged in the chair base portion 34 in contact with a lower surface of the chair knee frame member 32a3. The coupling cam 32d is coupled to the front end of the L shape back side arm member 32a1-1 in the back surface lower part of the frame member 32a1 by the rod shape third coupling link 32c3. As a result, by movement of the frame member 32a1, the coupling cam 32d is rotated via the coupling link 32c3, so that the chair knee frame member 32a3 is pivoted about the joint portion 32b2.

The frame drive unit 32e is composed of for example, although not specifically shown in the drawings, a linear actuator including a forward/backward rotation motor, a ball screw to be rotated forward and backward by the forward/backward rotation motor, and a nut member to be moved linearly forward and rearward by rotation of the ball screw. A fixed end of the linear actuator is fixed to the chair base portion 34, and the nut member of the linear actuator is coupled to the front end of the back side arm member 32a1-1 via an arm. Therefore, when the linear actuator of the frame drive unit 32e is driven, the frame member 32a1 is pivoted clockwise or anticlockwise about the joint portion 32b1 via the back side arm member 32a1-1. Along with this pivoting action of the frame member 32a1, the first chair leg frame member 32a4 is pivoted clockwise or anticlockwise about the joint portion 32b3 via the first coupling link 32c1, and at the same time, the coupling cam 32d is rotated forward and backward via the third coupling link 32c3. Thus, the chair knee frame member 32a3 is pivoted clockwise or anticlockwise about the joint portion 32b2. Along with the pivoting action of the chair knee frame member 32a3, the second chair leg frame member 32a5 is pivoted clockwise or anticlockwise about the joint portion 32b4 via the second coupling link 32c2.

In the vicinity of the nut member of the frame drive unit 32e, a flat posture detection sensor 103 for detecting a position of the nut member of the frame drive unit 32e so as to detect the reclining angle θr to be described later of the seat guide mechanism unit 32 is arranged. The flat posture detection sensor 103 inputs the detected reclining angle θr of the seat guide mechanism unit 32 to the control section 100. Instead of arranging the flat posture detection sensor 103, by arranging a rotation angle detection sensor in a rotation point of the tilt action or the joint portion 32b1 or by arranging an inclination angle sensor in the seat guide mechanism unit 32, the reclining angle θr can be detected.

In the control section 100, a determination section 100d determines whether the wheelchair 13 is in the flat posture or the chair posture based on the reclining angle θr detected by the flat posture detection sensor 103, so that the drive of the frame drive unit 32e is controlled.

Therefore, the first and second coupling links 32c1, 32c2 and the coupling cam 32d transmit the pivoting action of the frame member 32a1 by the drive of the frame drive unit 32e to the chair knee frame member 32a3, the first chair leg frame member 32a4, and the second chair leg frame member 32a5 serving as other frame members. By an extending and contracting action of the frame drive unit 32e (forward and rearward action of the nut member and the arm of the linear actuator), the frame members 32a are moved via the coupling links 32c and the coupling cam 32d, and a shape of the seat guide mechanism unit 32 is changed by this movement of the frame members 32a.

The wheelchair 13 can change the angle relationship among the frame members 32a of the seat guide mechanism unit 32 from the chair angle to the bed angle. Here, the “chair angle” is the angle relationship in which the reclining angle θr to be described later is 45° or more and 90° or less. The posture of the seat portion 31 supported by the seat guide mechanism unit 32 is changed to follow the angle relationship among the frame members 32a of the seat guide mechanism unit 32, so as to change the body posture of the care-receiver. That is, when the angle relationship among the frame members 32a of the seat guide mechanism unit 32 is the chair angle, the care-receiver is in the seating body posture. When the angle relationship among the frame members 32a of the seat guide mechanism unit 32 is the bed angle, the care-receiver is in the upward facing body posture. Similarly, the angle relationship among the frame members 32a of the seat guide mechanism unit 32 can be changed from the bed angle to the chair angle. Along with this change, the posture of the seat portion 31 is changed, so that the care-receiver can change the body posture between the upward facing body posture and the seating body posture.

The seat inclination mechanism unit 33 is composed of the extension and contraction drive unit 33a and a rotation support portion 33b. As shown in FIG. 4A, the rotation support portion 33b is provided on the lower side of a part between the chair back bottom member 31a and the chair waist bottom member 31b, and rotatably couples the seat guide mechanism unit 32. The rotation support portion 33b is a block shape member positioned in a rear end (in the vicinity of the joint portion 32b1) of the frame member 32a2. The extension and contraction drive unit 33a arranged in the chair base portion 34 is coupled to the chair waist frame member 32a2, and pivots the chair waist frame member 32a2 about the rotation support portion 33b.

The extension and contraction drive unit 33a is an extendable and contractible member composed of a linear actuator. The linear actuator of the extension and contraction drive unit 33a is composed of for example, although not specifically shown in the drawings, a forward/backward rotation motor, a ball screw to be rotated forward and backward by the forward/backward rotation motor, and a nut member to be moved linearly forward and rearward by rotation of the ball screw. A fixed end of the linear actuator is fixed to the chair base portion 34, and the nut member of the linear actuator is coupled to a part of the chair waist frame member 32a2 in the vicinity of the joint portion 32b2 via an arm. When the extension and contraction drive unit 33a is extended and contracted (when the nut member and the arm are moved forward and rearward by the linear actuator), the chair waist frame member 32a2 of the seat guide mechanism unit 32 is pushed (or pulled) by the extension and contraction drive unit 33a and rotated about the rotation support portion 33b while maintaining the angle relationship in the seat guide mechanism unit 32, so that the tilt action is performed. Similarly, the seat portion 31 is also rotated about the rotation support portion 33b while maintaining the posture thereof, so that the tilt action is performed. As a result, while not changing the body posture, the care-receiver is rotated about the rotation support portion 33b.

In the vicinity of the nut member of the extension and contraction drive unit 33a, a tilt posture detection sensor 102 for detecting a position of the nut member of the extension and contraction drive unit 33a so as to detect a tilt angle θt of the chair waist bottom member 31b is arranged. The tilt posture detection sensor 102 outputs the detected tilt angle θt of the chair waist bottom member 31b to the control section 100. Even in a case where a rotation angle detection sensor is arranged in the rotation point of the tilt or the joint portion 32b1 of the rotation support portion 33b or in a case where an inclination angle sensor is arranged in the seat portion 31 instead of arranging the tilt posture detection sensor 102, the tilt angle θt of the chair waist bottom member 31b can be detected. In the control section 100, the determination section 100d determines whether the wheelchair is in the tilt posture or a non-tilt posture (posture other than the tilt posture) based on the tilt angle θt detected by the tilt posture detection sensor 102, so that the drive of the extension and contraction drive unit 33a is controlled.

As shown in FIG. 4A, the angle θt of the chair waist bottom member 31b with respect to a horizontal line 40 along the horizontal direction (the direction parallel to the floor surface on which the bed 11 is mounted is called as the “horizontal direction” in this description) is called as the “tilt angle”. In FIG. 4A, the tilt angle θt is 0°.

As described above, the posture of the seat portion 31 with θr=θt=0° is the flat posture. As shown in FIG. 3C, the flat posture is the posture where the frame members 32a and the seat portion 31 are horizontal, and at this time, the care-receiver is supported in the upward facing body posture.

In a case where the wheelchair 13 is used in the chair posture in the first embodiment, the tilt angle θt is −5°≦θt≦+5°, and the reclining angle θr is 45°<θr<90°. The chair posture of the first embodiment is the posture where the tilt angle θt of the chair waist bottom member 31b supported by the chair shape seat guide mechanism unit 32 is −5°≦θt≦+5°, the chair back bottom member 31a is raised as shown in FIG. 3A, a part of the chair knee bottom member 31c on the front end side (on the side of the first chair leg bottom member 31d) is inclined to the slightly upper side of the chair waist bottom member 31b, and a part of the first chair leg bottom member 31d on the front end side (on the side of the second chair leg bottom member 31e) is lowered to the lower side. The tilt angle θt of the wheelchair 13 in the chair posture is −5°≦θt≦+5° in order to provide a sufficient field of vision to the care-receiver irrespective of a body state of the care-receiver at the time of using the wheelchair. For example, there is a case where a motion range of the joints of the care-receiver is narrowed due to contracture or the like and the posture cannot be changed to the reclining angle θr which is sufficient for obtaining the field of vision. Even in such a case, by adjusting the tilt angle θt in the range of −5°≦θt≦+5°, the angle of the back, that is, the direction of eye lines is adjusted within a range where a seat of the care-receiver is substantially horizontal, so that the field of vision of the care-receiver can be ensured.

As described above, the rotation support portion 33b is the block shape member positioned in the rear end (in the vicinity of the joint portion 32b1) of the frame member 32a2 supporting the chair waist bottom member 31b. By this rotation support portion 33b, the seat guide mechanism unit 32 and the entire seat portion 31 can be positioned higher than the height of the base portion 23 of the bed main portion 12 by the tilt action.

Successively, with using a flowchart of FIG. 2, combination actions of combining the wheelchair 13 and the bed main portion 12 under control of the control section 100 will be described.

Firstly, in Step S01 of FIG. 2, the wheelchair 13 in the chair posture shown in FIG. 3A is moved to a combination space on the side of the bed main portion 12 (refer to FIG. 1A). This Step S01 is a wheelchair movement step. In Step S01, the care-receiver manipulates the mode selection button of the operation unit 37, selects the “movement mode”, and moves the wheelchair 13 so as to move the wheelchair 13 to the combination space on the side of the bed main portion 12 (refer to FIG. 1A). The wheelchair 13 is moved by inputting the direction and speed through manipulating the joystick of the operation unit 37 by the care-receiver, so as to drive the electric drive unit 42 under the control of the control section 100 and rotate the omnidirectional movement wheels 35. Specifically, as shown in FIG. 1A, the care-receiver in the wheelchair 13 separated from the bed main portion 12 manipulates the operation unit 37 and moves the wheelchair 13 close to the bed main portion 12 in order to lie on the combined bed 11. Then, a side surface of the chair base portion 34 faces an opening part of the storage region 23a serving as the recess part of the base portion 23, so that the wheelchair is placed at a combining preparation position (refer to FIG. 5). It should be noted that in a case where the wheelchair 13 is to be stopped at this time, the wheelchair 13 can be stopped by returning the joystick of the operation unit 37 to the neutral position by the care-receiver.

Next, in a state where the bed main portion 12 and the wheelchair 13 are roughly positioned in Step S01, the mode selection button of the operation unit 37 is manipulated and the “combination mode” is selected in Step S02 of FIG. 2. This Step S02 is a combination start step.

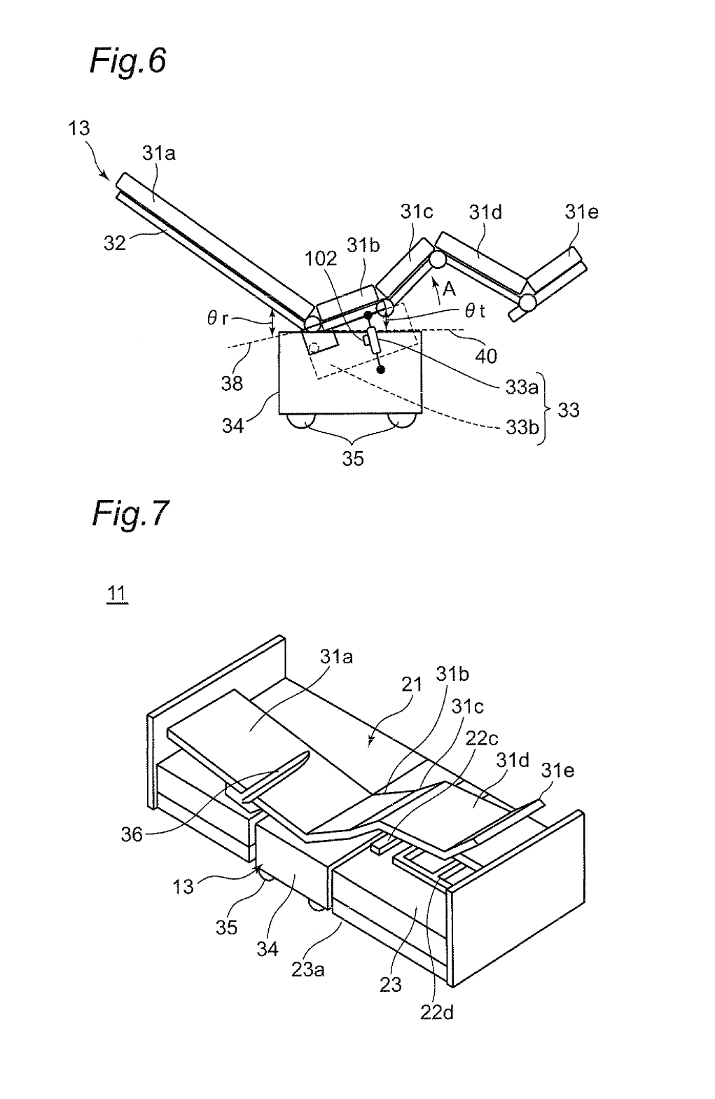

Next, in Step S03 of FIG. 2, the care-receiver changes the posture of the wheelchair 13 in the chair posture shown in FIG. 3A to the tilt posture shown in FIG. 3B. This Step S03 is a combining preparation step. In this Step S03, the care-receiver manipulates the mode selection button of the operation unit 37 and selects the “tilt change mode”, so as to perform the tilt action of the seat portion 31 of the wheelchair 13 in the chair posture. In a case where the tilt change mode is selected in the operation unit 37, the wheelchair 13 performs the tilt action based on the input of the joystick of the operation unit 37. Specifically, when the joystick of the operation unit 37 is inclined rearward, the extension and contraction drive unit 33a is driven under the control of the control section 100, the entire frame members 32a of the seat guide mechanism unit 32 are rotated about the joint portion 32b1 of the rotation support portion 33b, the seat portion 31 is rotated while maintaining the posture of the seat portion 31, and the tilt angle θt is changed in the direction in which the head is lowered (in the direction in which the tilt angle θt is increased) (specifically, in the direction of an arrow A of FIG. 6 (anticlockwise direction)). This Step S03 is a step of changing the posture of the wheelchair 13 to the posture shown in FIG. 8 through FIGS. 4A to 6. The tilt change mode for performing the tilt action as the combining preparation step is controlled so as to be selectable only in a state where the combination mode is selected in Step S02 described above.

In Step S03, for combining preparation of the bed main portion 12 and the wheelchair 13, the posture of the seat portion 31 is changed from the chair posture to the tilt posture by the tilt action in such a manner that a position of the second chair leg bottom member 31e (footrest) is higher than the base portion 23. By doing so, the combining preparation can be performed while the body posture of the care-receiver sitting in the wheelchair 13 is maintained to be the seating body posture. Thereby, even at the time of combining the bed main portion 12 and the wheelchair 13, a burden on the care-receiver due to a change of the body posture can be reduced.

Next, in Step S04 of FIG. 2, the wheelchair 13 whose posture is changed to the tilt posture shown in FIG. 3B to finish a combining preparation action is moved by the care-receiver into the storage region 23a serving as a recess for storing the chair base portion 34 in the base portion 23. This Step S04 is a combining movement step. Specifically, by inclining the joystick of the operation unit 37 to the side of the bed main portion 12, the care-receiver drives the electric drive unit 42 under the control of the control section 100 to rotate the omnidirectional movement wheels 35, and then, the wheelchair 13 is moved into the storage region 23a in the bed main portion 12 while maintaining the tilt posture. This movement of the wheelchair 13 of Step S04 may be automatically performed after inclining the joystick or may be manually performed by moving the joystick of the operation unit 37 by the care-receiver. However, in order to accurately combine the bed main portion 12 and the wheelchair 13, it is desirable to enhance positional precision by automatically moving the wheelchair 13.

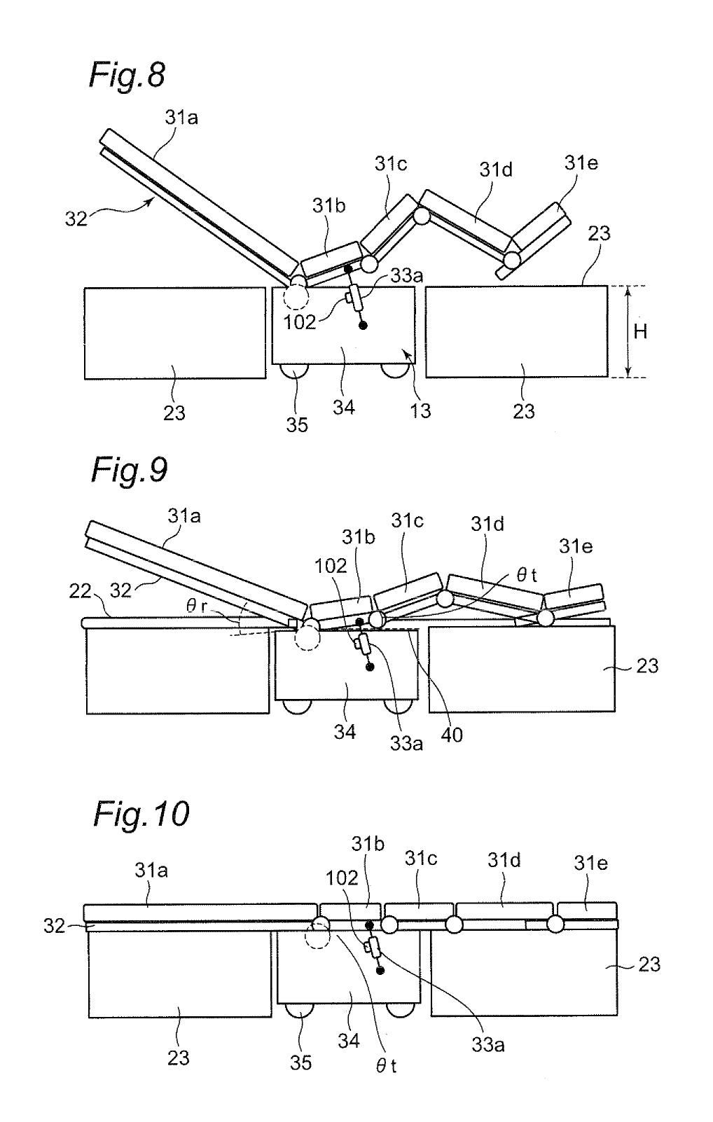

Next, in Step S05 of FIG. 2, the care-receiver changes the posture of the wheelchair 13 in the tilt posture to the flat posture shown in FIG. 3C. This Step S05 is a bed formation step. Further, under the control of the control section 100, by sending an action command from the wheelchair control section 41 to the bed control section 43, driving the bed elevating device 43D, and lifting the base portion 23 of the bed main portion 12, the seat portion 31 of the wheelchair 13 is brought in contact with the bed bottom guide member 22 of the bed main portion 12. By lifting the base portion 23 in such a way, height is matched between a surface of the seat portion 31 of wheelchair 13 and a surface of the half bed bottom portion 21 of the bed main portion 12. This Step S05 is a step of changing the posture of the wheelchair 13 to a posture shown in FIG. 10 through FIGS. 8 to 9.

It should be noted that in the combining mode selectable by the mode selection button of the operation unit 37, actions from Step S03 to Step S05 may be continuously performed based on the input of the joystick. That is, the combination mode is selected in Step S02, the joystick of the operation unit 37 is inclined to the side of the bed main portion 12, the tilt action in Step S03 is performed under the control of the control section 100, and the posture of the wheelchair 13 is changed to the tilt posture shown in FIG. 8. Successively, after the tilt posture detection sensor 102 detects that the posture of the wheelchair 13 is changed to the tilt posture, the flow moves to Step S04, and the wheelchair is automatically moved into the storage region 23a in the bed main portion 12. The movement of the wheelchair 13 into the storage region 23a is detected by an environment sensor 101 to be described later. After the movement of the wheelchair 13 into the storage region 23a is detected, the flow moves to Step S05, the posture of the wheelchair 13 is changed to the flat posture, and the action command is sent from the wheelchair control section 41 to the bed control section 43. Hy lifting the base portion 23 of the bed main portion 12 based on this action command, the seat portion 31 of the wheelchair 13 is brought in contact with the bed bottom guide member 22 of the bed main portion 12, and the height of the seat portion 31 of wheelchair 13 is matched with the height of the half bed bottom portion 21 of the bed main portion 12. This series of actions are performed only while the joystick of the operation unit 37 is inclined to the side of the bed main portion 12.

Successively, in the states of the flowchart of FIG. 2, the state of the bed main portion 12 or the wheelchair 13 will be described.

FIG. 5 is a perspective view of the bed 11 in a combining preparation state according to the first embodiment. FIG. 6 is a schematic side view of the wheelchair 13 in the combining preparation state according to the first embodiment. FIGS. 5 and 6 are views for illustrating Step S03 and Step S04 in FIG. 2.

In Step S03 of FIG. 2, firstly, in the wheelchair 13, in a state where a posture of the seat guide mechanism unit 32 is maintained, the seat guide mechanism unit 32 is pivoted in the direction of the arrow A of FIG. 6 (anticlockwise direction of FIG. 6) by the drive of the extension and contraction drive unit 33a, so that the tilt action is performed.

As shown in FIGS. 5 and 6, when the posture of the wheelchair 13 is changed to the tilt posture, the position of the second chair leg bottom member 31e is higher than the position in a case of the chair posture shown in FIG. 3A. At this time, the second chair leg bottom member 31e of the wheelchair 13 in the tilt posture is higher than height H from the mount floor surface of the base portion 23 of the bed main portion 12 (refer to FIG. 5). A position of an upper end of the chair back bottom member 31a is lower than the position in a case of the chair posture shown in FIG. 3A but higher than the height H of the base portion 23 of the bed main portion 12. That is, in the wheelchair 13 in the combining preparation state of the first embodiment, all the seat portion 31 is placed at a position higher than the base portion 23 by performing the tilt action. Therefore, while the posture of the care-receiver sitting in the wheelchair 13 is maintained to be the seating body posture, the wheelchair 13 can be moved into the storage region 23a without letting the seat portion 31 collide with the base portion 23. At this time, the body posture of the care-receiver is the seating body posture which is the same as that at the time of the chair posture. Thus, at the time of combining the bed main portion 12 and the wheelchair 13, the burden on a body of the care-receiver is a little.

It should be noted that in the first embodiment, the reclining angle θr of the wheelchair 13 in the tilt posture is 45°<θr<90° as well as the reclining angle θr of the wheelchair 13 in the chair posture, and the tilt angle θt is 20°<θt<50°. The tilt angle θt of the wheelchair 13 in the tilt posture is 20°<θt<50° in order to ensure a sufficient field of vision of the care-receiver for confirming safety at the time of moving forward, leftward, and rightward without making a blind angle on the front side of the care-receiver by the body in a case where the care-receiver moves the wheelchair 13 in the tilt posture while the height of the seat portion 31 is higher than the base portion 23. The blind angle by the body is for example a blind angle by feet or the like of the care-receiver. In the first embodiment, when the reclining angle θr is a reclining angle θr ° in the “tilt posture” and the tilt angle θt is a tilt angle θt0 in the “tilt posture”, the reclining action is started. That is, the bed 11 of the first embodiment performs the combination or separation actions in a state of θr=θr0 and θt=θt0 to be described later.

It should be noted that the wheelchair 13 has the environment sensor 101 (refer to FIG. 1B) such as a laser sensor or a contact detection sensor on a side surface of the chair base portion 34 (for example, on a side surface on the side of coming close to the bed main portion 12 and front and rear surfaces). By this environment sensor 101, at the time of combination, a position of the storage region 23a of the base portion 23 is obtained, and the wheelchair 13 is placed on the side of the bed main portion 12 at the combining preparation position facing an inlet of the storage region 23a. After that, the wheelchair 13 is moved into the storage region 23a from the combining preparation position. When the wheelchair comes to a combination position where the entire wheelchair 13 comes into the storage region 23a, the movement of the wheelchair 13 is stopped, and the left armrest 36a is manually pivoted to the back surface side and accommodated in the back surface of the chair back bottom member 31a. In the first embodiment, the contact sensor serving as one example of the environment sensor 101 is arranged around the chair base portion 34 of the wheelchair 13 (for example on the side surface on the side of coming close to the bed main portion 12 and the front and rear surfaces). When the wheelchair 13 comes into and is stored in the storage region 23a of the bed main portion 12, the contact sensor 101 is brought into contact with the bed main portion 12 and detects that the wheelchair 13 is stored in the storage region 23a. Upon this detection of the contact sensor 101, the frame drive unit 32e and the extension and contraction drive unit 33a are driven under the control of the control section 100, and the posture of the wheelchair 13 is changed from the tilt posture and the chair posture to the non-tilt posture and the flat posture. In other words, by changing the posture of the wheelchair 13 from the tilt posture to the non-tilt posture and at the same time, changing the posture from the chair posture to the flat posture, the posture of the wheelchair 13 is eventually changed from the tilt posture to the flat posture.

FIG. 7 is a perspective view of the bed 11 in which the wheelchair 13 according to the first embodiment is moved into the storage region 23a and the left armrest 36a is accommodated. FIG. 8 is a schematic side view of the bed 11 in which the wheelchair 13 according to the first embodiment is moved into the storage region 23a.

FIGS. 7 and 8 are views for illustrating Step S04 in FIG. 2. In Step S04, the posture of the seat portion 31 of the wheelchair 13 is the tilt posture, and the position of the second chair leg bottom member 31e is higher than the height H of the base portion 23. The chair back bottom member 31a is also higher than the height H of the base portion 23. That is, since the seat portion 31 is higher than the base portion 23, the seat portion can be moved into the storage region 23a without colliding with the base portion 23.

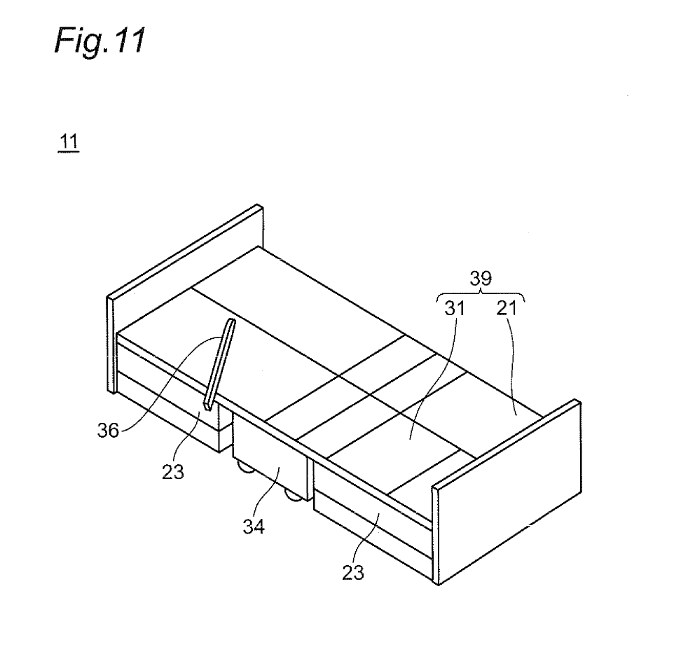

FIG. 9 is a schematic side view of the bed 11 showing a state of the middle of a posture change of the seat portion 31 according to the first embodiment from the tilt posture to the flat posture. FIG. 10 is a schematic side view of the combined bed 11 according to the first embodiment. FIG. 11 is a perspective view of the combined bed 11 according to the first embodiment.

As shown in FIGS. 9 and 10, by driving the seat guide mechanism unit 32 and the seat inclination mechanism unit 33, the posture of the seat portion 31 is changed from the tilt posture to the flat posture and the non-tilt posture. Specifically, by driving the frame drive unit 32e, the frame member 32a1 supporting the chair back bottom member 31a is brought downward so as to decrease the reclining angle θr. In conjunction with movement of the frame member 32a1 supporting the chair back bottom member 31a, other frame members 32a3, 32a4, 32a5 are moved. As a result, the posture of the seat guide mechanism unit 32 comes close to the flat posture from the chair posture.

In Step S05 of FIG. 2, by sending control signals from the wheelchair control section 41 to the frame drive unit 32e and the extension and contraction drive unit 33a at the same time, the seat guide mechanism unit 32 is actuated by the frame drive unit 32e and at the same time, the seat inclination mechanism unit 33 is actuated by the extension and contraction drive unit 33a so as to decrease the tilt angle θt. That is, in Step S05 of FIG. 2, by driving the frame drive unit 32e and the extension and contraction drive unit 33a at the same time, the seat guide mechanism unit 32 and the seat inclination mechanism unit composing the wheelchair 13 are actuated at the same time, so that the posture of the seat portion 31 is changed to the flat posture.

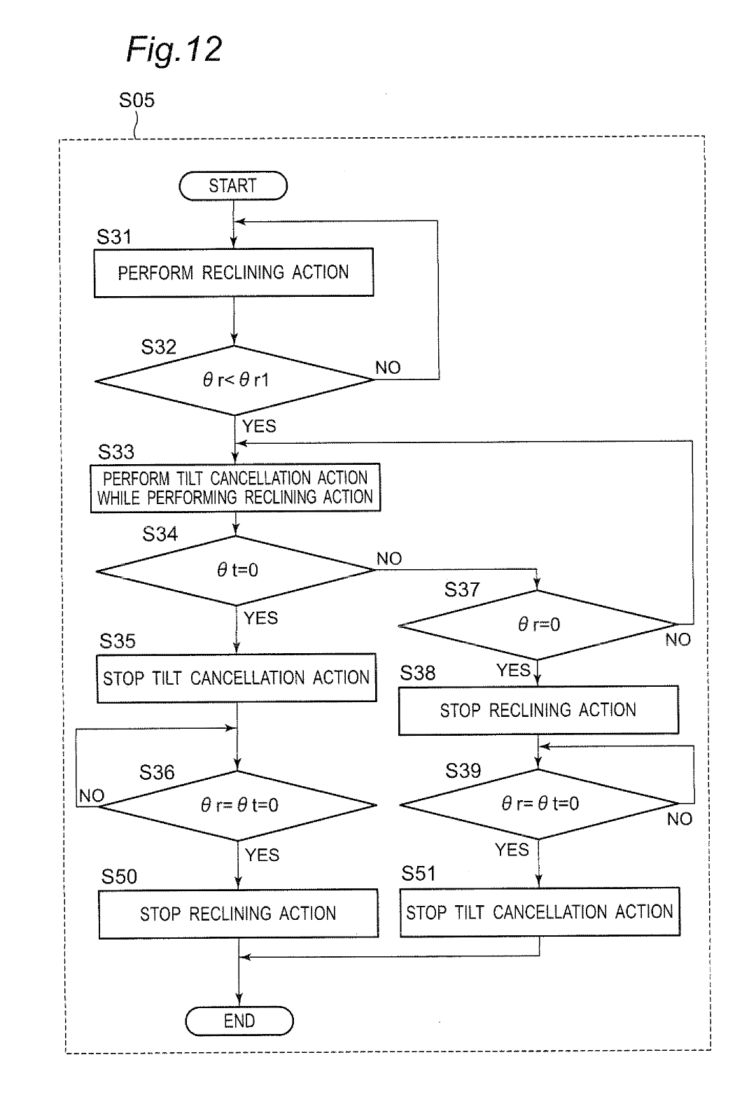

Hereinafter, a detailed flow of Step S05 of FIG. 2 will be described based on a flowchart of FIG. 12.

This Step S05 is a step for performing actions of changing the posture of the wheelchair 13 in the tilt posture to the flat posture and the non-tilt posture shown in FIG. 3C after moving and combining the wheelchair 13 in the tilt posture into the storage region 23a of the bed main portion 12. Specifically, Step S05 is characterized by cancelling rotation movement of the chair back bottom member 31a by the tilt action and rotation movement by the reclining action thereof in the combination actions.

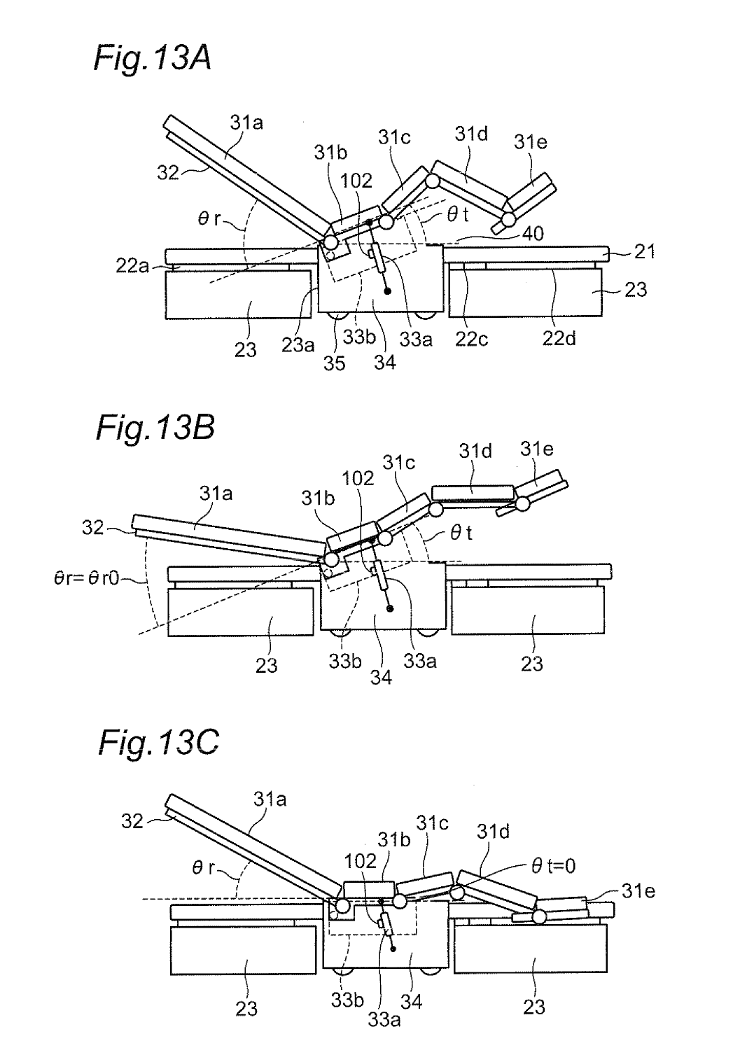

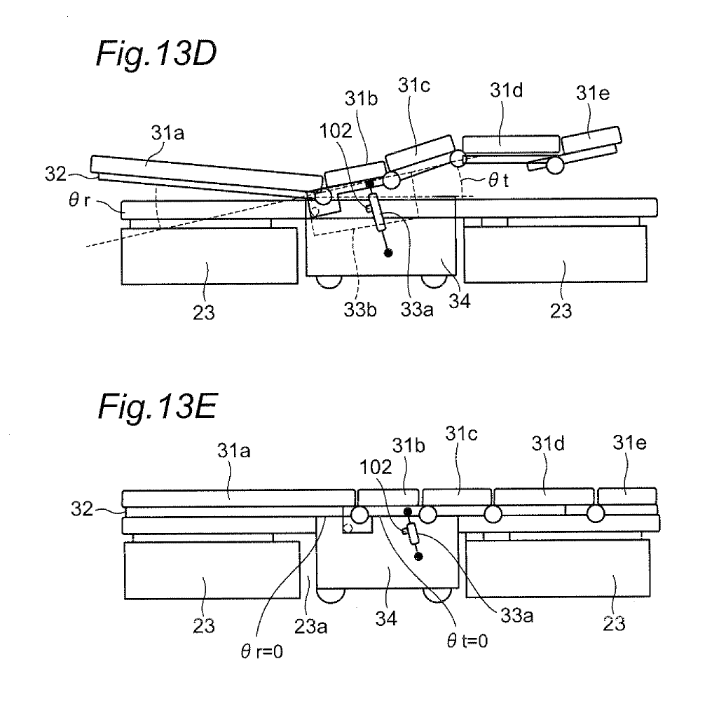

Firstly, at a time point of starting Step S05 of FIG. 12, the wheelchair 13 in the storage region 23a is in a state of the tilt posture of FIG. 13A. The wheelchair 13 in the tilt posture indicates that the wheelchair 13 is in the chair posture as described above.

Next, in Step S31, by driving the frame drive unit 32e under the control of the control section 100 and actuating the seat guide mechanism unit 32 so as to perform the reclining action, the posture of the seat portion 31 is changed in the direction in which the reclining angle θr is decreased (in the direction in which the posture of the seat portion 31 is changed from the chair posture to the flat posture). When this reclining action is started, the reclining angle θr is the reclining angle θr0 in the tilt posture (refer to FIG. 13B). The tilt angle θt is the tilt angle θt0 in the tilt posture. From such a state, the reclining action is started. That is, in the first embodiment, in a state of θr=θr0 and θt=θt0, the combination or separation actions are started.

After starting the reclining action, the determination section 100d of the control section 100 determines whether or not the reclining angle θr is smaller than an at-combination conjunction start angle θr1, that is, whether or not θr<θr1 in Step S32. In a case where the determination section 100d determines that the reclining angle θr is the at-combination conjunction start angle θr1 or more (in a case of NO in Step S32), the flow returns to Step S31 and the reclining action is continued. In a case where the determination section 100d determines that the reclining angle θr is smaller than the at-combination conjunction start angle θr1 (in a case of YES in Step S32), the flow advances to Step S33. It should be noted that a relationship between the at-combination conjunction start angle θr1 and the tilt angle θt0 in the tilt posture is θr1>θt0. This is not to bring the back of the care-receiver sitting in the wheelchair 13 lower than the horizontal plane in the tilt posture with the tilt angle θt0. The at-combination conjunction start angle θr1 is one example of a predetermined angle.

In Step 933, as shown in FIG. 13D, while driving the extension and contraction drive unit 33a under the control of the control section 100 so as to perform the reclining action, a tilt cancellation action of changing the posture of the seat portion 31 from the tilt posture to the non-tilt posture is performed. The tilt cancellation action is an action of changing the seat portion 31 in the direction in which the tilt angle θt is decreased from the tilt posture. In the first embodiment, as described above, by performing the tilt cancellation action while performing the reclining action (while changing the posture of the seat portion 31 from the chair posture to the flat posture), the tilt cancellation action can be performed while the reclining angle θr of the chair back bottom member 31a is maintained to be constant.

Next, in Step S34, the determination section 100d determines whether or not the tilt angle θt is zero. In a case where the determination section 100d determines that the tilt angle θt is zero (YES in Step S34), it means that the seat portion 31 is in the non-tilt posture. Thus, the flow advances to Step S35. In a case where the determination section 100d determines that the tilt angle θt is not zero (NO in Step S34), the flow advances to Step S37.

In Step S35, the drive of the extension and contraction drive unit 33a is stopped under the control of the control section 100 and the tilt cancellation action is stopped. It should be noted that although the tilt cancellation action is stopped, the drive of the frame drive unit 32e is continued under the control of the control section 100, and the reclining action to the flat posture is continued.

Next, in Step S36, the determination section 100d determines whether or not the reclining angle θr is zero after the tilt angle θt is zero as shown in FIG. 13E. That is, in Step S36, the determination section 100d determines whether or not both the reclining angle θr and the tilt angle θt are zero, that is, whether or not θr=θt=0. In a case where the determination section 100d determines that both the reclining angle θr and the tilt angle θt are zero (YES in Step S36), it means that the seat portion 31 is in the flat posture and the non-tilt posture. Thus, the reclining action is stopped in Step S50 and this series of combination actions are finished. In a case where the determination section 100d determines that the reclining angle θr and the tilt angle θt are not both zero (NO in Step S36), the reclining action is repeated until the reclining angle θr becomes zero.

In Step S37, the determination section 100d determines whether or not the reclining angle θr is zero. In a case where the determination section 100d determines that the reclining angle θr is zero (YES in Step S37), it means that the seat portion 31 is in the flat posture. Thus, the flow advances to Step S38. In a case where the determination section 100d determines that the reclining angle θr is not zero (NO in Step S37), the flow returns to Step 933, the tilt cancellation action is performed while performing the reclining action, and the determination section 100d determines whether or not the tilt angle θt is zero in Step S34.

It should be noted that among Step 934 (θt=0) and Step S37 (θr=0), Step S34 is performed earlier because it is desirable that the tilt angle θt becomes zero earlier. Therefore, in the first embodiment, by appropriately setting speed of the reclining action and speed of the tilt cancellation action, the first embodiment is constructed so that the tilt angle θt becomes zero earlier than the reclining angle θr.

In Step S38, the drive of the frame drive unit 32e is stopped under the control of the control section 100 and the reclining action is stopped. It should be noted that although the reclining action is stopped, the drive of the extension and contraction drive unit 33a is continued under the control of the control section 100, and the tilt cancellation action is continued.

Next, in Step S39, the determination section 100d determines whether or not the tilt angle θt is zero after the reclining angle θr is zero as shown in FIG. 13E. That is, in Step S39, the determination section 100d determines whether or not both the reclining angle θr and the tilt angle θt are zero, that is, whether or not θr=θt=0. In a case where the determination section 100d determines that both the reclining angle θr and the tilt angle θt are zero (YES in Step S39), it means that the seat portion 31 is in the flat posture and the non-tilt posture. Thus, the tilt cancellation action is stopped in Step S51 and this series of combination actions are finished. In a case where the determination section 100d determines that the reclining angle θr and the tilt angle θt are not both zero (NO in Step S39), the tilt cancellation action is repeated until the tilt angle θt becomes zero.

The series of combination actions of Step S05 are described above.

In such a way, in the first embodiment, when the wheelchair 13 is combined with the bed main portion 12, while driving the frame drive unit 32e under the control of the control section 100 and actuating the seat guide mechanism unit 32 so as to perform the reclining action of changing the posture of the seat portion 31 from the chair posture to the flat posture, the extension and contraction drive unit 33a is driven and the tilt action (tilt cancellation action) of changing the posture of the seat portion 31 from the tilt posture to the non-tilt posture is performed at the same time. As a result, the posture of the seat portion 31 is changed in order of FIG. 13A, FIG. 13B, FIG. 13D, and FIG. 13E. That is, from the state of FIG. 13A in which the seat portion 31 is in the tilt posture, the reclining action is firstly started. After the reclining angle θr is decreased to a predetermined angle (at-combination conjunction start angle θr1), the tilt cancellation action is started while continuing the reclining action, so that the posture is changed from the tilt posture to the non-tilt posture. By performing the two actions at the same time, the posture is changed from the state of FIG. 13B to the state of FIG. 13D (without going through the state of FIG. 13C). Therefore, after the tilt cancellation action is performed while the reclining angle θr of the chair back bottom member 31a is maintained to be a predetermined angle and then, the posture becomes the non-tilt posture, the posture of the seat portion 31 including the chair back bottom member 31a is changed to the flat posture. As a result, steps of the actions are shortened more than in a case of separately performing the reclining action and the tilt action. In a case where the tilt action is performed after the reclining action, after performing the reclining action of the chair back bottom member 31a in order of FIG. 13A, FIG. 13B, FIG. 13C, and FIG. 13E and changing the posture from the chair posture to the flat posture, the tilt cancellation action from the tilt posture to the non-tilt posture is performed. By this tilt cancellation action, the chair back bottom member 31a is raised again as shown in FIG. 13C from the state of FIG. 13B, and the chair back bottom member 31a is unnecessarily inclined and moved. Thus, the burden may be imposed on the care-receiver. Meanwhile, in the first embodiment, by performing the reclining action and the tilt cancellation action at the same time, the tilt cancellation action is performed while the chair back bottom member 31a is maintained at a predetermined angle. Thus, the chair back bottom member 31a is prevented from being unnecessarily inclined and moved, so that the burden on the care-receiver can be reduced.

In other words, by such combination actions, the chair back bottom member 31a comes close to the chair base portion 34 along with a decrease in the reclining angle θr. Conversely, the chair back bottom member 31a goes away from the chair base portion 34 by a decrease in the tilt angle θt. That is, in the bed formation step at the time of the combination in the first embodiment, by performing the reclining action and the tilt action at the same time, a change of the height of the seat portion 31 is offset, and the posture can be changed to the flat posture while maintaining a state where the height of the seat portion 31 is higher than the base portion 23 of the bed main portion 12. The second chair leg bottom member 31e comes close to the chair base portion 34 along with the decrease in the tilt angle θt. Conversely, the second chair leg bottom member 31e goes away from the chair base portion 34 by the decrease in the reclining angle θr. That is, regarding the second chair leg bottom member 31e, the posture can also be changed to the flat posture while maintaining a state where the height of the seat portion is higher than the base portion 23 as well as the chair back bottom member 31a. As a result, while maintaining a state where the height of the seat portion 31 of the wheelchair 13 is higher than the height of the base portion 23 of the bed main portion 12, the posture can be changed from the tilt posture to the flat posture. Therefore, by the bed 11 of the first embodiment, after the combination with the bed main portion 12, the posture of the seat portion 31 of the wheelchair 13 can be changed. Thus, with the combination method of the first embodiment, the tilt posture where the burden is not imposed on the care-receiver is maintained during moving, and the posture of the wheelchair 13 is changed to the flat posture after the combination.

FIGS. 10 and 11 show the bed in a state where the posture of the seat portion 31 is changed to the flat posture. In the first embodiment, in Step S05 of FIG. 2, by driving the bed elevating device 43D and lifting the base portion 23 of the bed main portion 12 after the wheelchair 13 is brought into the flat posture, the bed bottom guide member 22 of the bed main portion 12 is brought in contact with the seat portion 31 of the wheelchair 13, and upper surfaces of the half bed bottom portion 21 and the seat portion 31 are set to have the same height, so that one bed bottom portion 39 can be formed by the half bed bottom portion 21 and the seat portion 31. That is, the bed 11 is formed by combining the bed main portion 12 and the wheelchair 13. At this time, both the half bed bottom portion 21 and the seat portion 31 are brought in contact with the bed bottom guide member 22, and the posture of the bed bottom portion 39 (the seat portion 31 and the half bed bottom portion 21) can be changed to a posture other than the flat posture by an action of the bed bottom guide member 22.

It should be noted that in the first embodiment, immediately after the wheelchair 13 is combined with the bed main portion 12, the one side armrest 36 is not accommodated but protrudes from the bed bottom portion 39 as shown in FIG. 11.

This is to prevent the care-receiver from slipping off the wheelchair 13 to the side by this armrest 36 at the time of combining the wheelchair 13 with the bed main portion 12. That is, the armrest 36 serves as a substitute of a railing for preventing fall. In a case where the wheelchair 13 combined with the bed main portion 12 is used as the bed 11, after the bed formation step, the care-receiver or a caregiver rotates the armrest 36 and moves the armrest 36 to the lower side of the bed bottom portion 39. It should be noted that the armrest 36 may be rotated by the electric drive unit 42.

Successively, the bed 11 serving as the electric nursing care bed will be described.

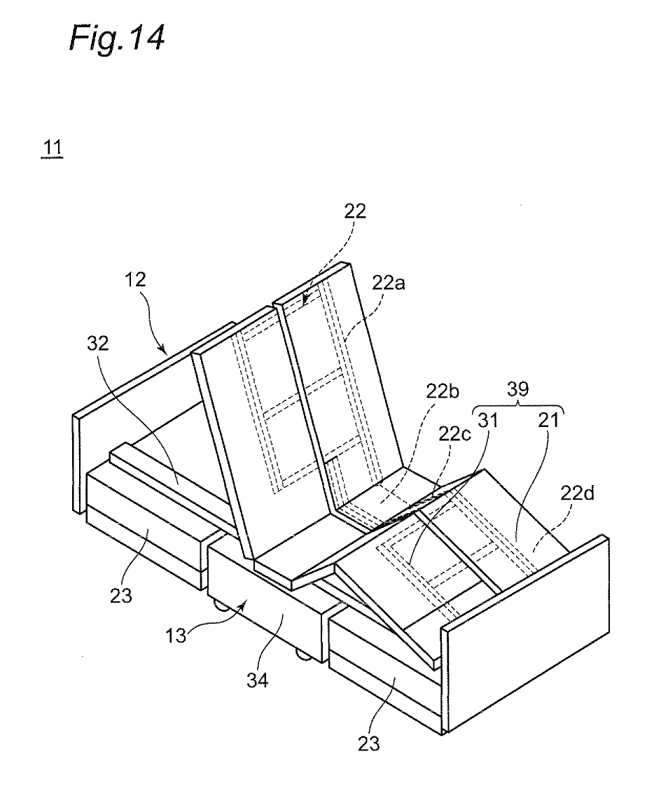

FIG. 14 is a perspective view of the bed 11 in a state where back lifting and knee lifting are performed according to the first embodiment. As shown in FIG. 14, in this bed 11, by driving the known bed bottom guide member drive device 22D under the control of the control section 100 and the bed control section 43, the parts of the half bed bottom portion 21 and the seat portion 31 around the back surface and the knees of the care-receiver are brought up by the bed bottom guide member 22, so that the posture can be the back lifting posture and the knee lifting posture.

In such a way, the bed 11 of the first embodiment can be utilized as the nursing care bed serving as the bed 11 whose part is separable as the wheelchair 13, in which the posture can be the back lifting posture and the knee lifting posture.

As described above, the combination method of the bed according to the first embodiment is characterized in that since the height of the chair back bottom member 31a and the second chair leg bottom member 31e is not lower than the base portion 23 of the bed main portion 12 upon the posture change of the seat portion 31 at the time of combining the wheelchair 13 with the bed main portion 12, there is no need for the leg lifting posture during the combination, and the combination can be performed while the body posture of the care-receiver is maintained to be the seating body posture. At this time, a change of the body posture of the care-receiver is only one change from the seating body posture to the upward facing body posture. As a result, with the bed 11 of the first embodiment, at the time of combining the wheelchair 13 with the bed main portion 12, the burden on the body of the care-receiver can be reduced.

It should be noted that the series of combination actions are executed only while the joystick of the operation unit 37 is inclined to the side of the bed main portion 12, and temporarily stopped while the joystick is placed at the neutral position or inclined in other direction. Thereby, even in a situation such as an approach of an individual during the combination, the actions can be temporarily stopped by a simple manipulation of the operation unit 37 by the care-receiver, so that safer combination actions can be realized.

It should be noted that the method of combining the wheelchair 13 in the tilt posture with the bed main portion 12 as described above may be used not only for the bed combination method but also for a bed separation method.

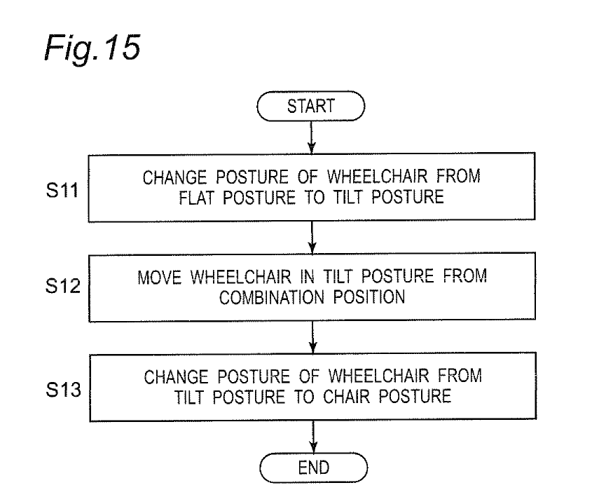

FIG. 15 is a flowchart showing a separation method and a separation method of the bed according to the first embodiment.

Firstly, in Step S11 of FIG. 15, after the base portion 23 of the bed main portion 12 is lowered and the seat portion 31 stops being brought in contact with the bed bottom guide member 22 and the base portion 23, the posture of the seat portion 31 of the wheelchair 13 is changed from the non-tilt posture and the flat posture to the tilt posture. This Step S11 is a separating preparation step. This Step S11 is a step of changing the posture of the wheelchair 13 to the posture shown in FIG. 8 through FIGS. 10 to 9.

Next, in Step S12 of FIG. 15, the wheelchair 13 in the tilt posture is moved in the direction in which the wheelchair is brought away from the storage region 23a of the base portion 23 of the bed main portion 12. This Step S12 is a separating movement step.

Next, in Step S13 of FIG. 15, the seat portion 31 performs the tilt action, and while the body posture of the care-receiver is maintained to be the seating body posture, the posture is changed from the tilt posture to the non-tilt posture and the chair posture. This Step S13 is a chair deformation step. In this Step S13, the position of the second chair leg bottom member 31e (footrest) is inclined to be lower than the base portion 23. This Step S13 is a step of changing the posture of the wheelchair 13 to the posture shown in FIG. 4A through FIGS. 8 to 6.

As described above, at the time of separating the wheelchair 13 from the bed main portion 12, there is no need for the leg lifting posture in the separating movement step. That is, the change of the body posture of the care-receiver is only one change from the upward facing body posture to the seating body posture, so that the burden on the care-receiver can be reduced.

It should be noted that although the tilt action and the reclining action of the wheelchair 13 are driven by the electric drive unit 42 in the first embodiment, the tilt action and the reclining action may be performed by human power of the caregiver or the like.

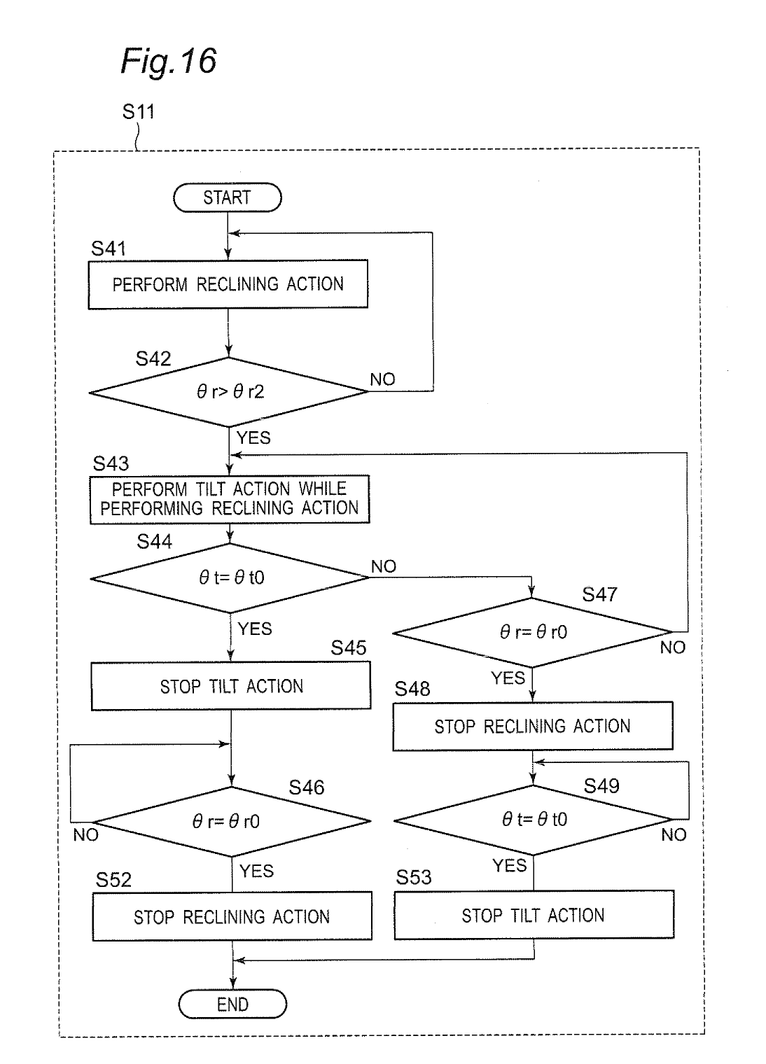

Hereinafter, a detailed flow of Step S11 of FIG. 15 will be described based on a flowchart of FIG. 16.

This Step S11 is the separating preparation step, that is, the step of, after lowering the base portion 23 of the bed main portion 12 and stopping being brought the base portion 23 in contact with the bed bottom guide member 22 of the seat portion 31, performing the actions of changing the posture of the seat portion 31 of the wheelchair 13 in the storage region 23a of the bed main portion 12 from the flat posture to the chair posture and changing the posture from the non-tilt posture to the tilt posture. The separation actions are characterized by cancelling rotation movement of the chair back bottom member 31a to the tilt posture and rotation movement to the chair posture.

Firstly, at a time point of starting the flow of FIG. 16, the wheelchair 13 in the storage region 23a is in a state of the flat posture of FIG. 13E.

Next, in Step S41, by driving the frame drive unit 32e under the control of the control section 100 and actuating the seat guide mechanism unit 32 so as to perform the reclining action, the posture of the seat portion 31 is changed in the direction in which the reclining angle θr is increased (in the direction in which the posture of the seat portion 31 is changed from the flat posture to the chair posture).

Next, after starting the reclining action, the determination section 100d of the control section 100 determines whether or not the reclining angle θr is larger than an at-separation conjunction start angle θr2, that is, whether or not θr>θr2 in Step S42. In a case where the determination section 100d determines that the reclining angle θr is the at-separation conjunction start angle θr2 or less (in a case of NO in Step S42), the flow returns to Step S41 and the reclining action is continued. In a case where the determination section 100d determines that the reclining angle θr is larger than the at-separation conjunction start angle θr2 (in a case of YES in Step S42), the flow advances to Step S43. It should be noted that in the first embodiment, the at-separation conjunction start angle θr2=5 deg as one example. The at-separation conjunction start angle θr2 is one example of a predetermined angle.

In Step S43, as shown in FIG. 13D, while driving the extension and contraction drive unit 33a under the control of the control section 100 so as to perform the reclining action, the tilt action of changing the posture of the seat portion 31 from the non-tilt posture to the tilt posture is performed. Specifically, in Step S43, while changing the posture of the seat portion 31 from the flat posture to the chair posture, the posture of the seat portion 31 is changed from the non-tilt posture to the tilt posture. In such a way, in Step S43, in a state where the reclining angle θr of the chair back bottom member 31a is constant, the tilt action is performed while performing the reclining action.

Next, in Step S44, the determination section 100d determines whether or not the tilt angle θt is the tilt angle θt0 in the tilt posture. In a case where the determination section 100d determines that the tilt angle θt is θt0 (YES in Step S44), it means that the seat portion 31 is in the tilt posture. Thus, the flow advances to Step S45. In a case where the determination section 100d determines that the tilt angle θt is not θt0 (NO in Step S44), the flow advances to Step S47.

In Step S45, the drive of the extension and contraction drive unit 33a is stopped under the control of the control section 100 and the tilt action is stopped. It should be noted that although the tilt action is stopped, the drive of the frame drive unit 32e is continued under the control of the control section 100 and the reclining action is continued.

Next, in Step S46, as shown in FIG. 13B, the determination section 100d determines whether or not the reclining angle θr is the reclining angle θr0 in the tilt posture, that is, whether or not θr=θr0. In a case where the determination section 100d determines that the reclining angle θr is θr0 (YES in Step S47), it means that the seat portion 31 is in the tilt posture. Thus, the reclining action is stopped in Step S52 and this series of separation actions are finished. In a case where the determination section 100d determines that the reclining angle θr is not θr0 (NO in Step S47), the reclining action is repeated until the reclining angle θr becomes θr0.

In Step S47, the determination section 100d determines whether or not the reclining angle θr is θr0. In a case where the determination section 100d determines that the reclining angle θr is θr0 (YES in Step S47), it means that the seat portion 31 is in the chair posture. Thus, the flow advances to Step S48. In a case where the determination section 100d determines that the reclining angle θr is not θr0 (NO in Step S47), the flow returns to Step S43.

In Step S48, the drive of the frame drive unit 32e is stopped under the control of the control section 100 and the reclining action is stopped. It should be noted that although the reclining action is stopped, the drive of the extension and contraction drive unit 33a is continued under the control of the control section 100, and the tilt action is continued.

Next, in Step S49, as shown in FIG. 13A, the determination section 100d determines whether or not the tilt angle θt is the tilt angle θt0 in the tilt posture, that is, whether or not θt=θt0. In a case where the determination section 100d determines that the tilt angle θt is θt0 (YES in Step S49), it means that the seat portion is in the chair posture. Thus, the tilt action is stopped in Step S53 and this series of separation actions are finished. In a case where the determination section 100d determines that the tilt angle θt is not θt0 (NO in Step S49), the tilt action is repeated until the reclining angle θt becomes θt0.

The series of separation actions of Step S11 are described above.

In such a way, in the first embodiment, when the wheelchair 13 is separated from the bed main portion 12, while driving the frame drive unit 32e under the control of the control section 100 and actuating the seat guide mechanism unit 32 so as to perform the reclining action of changing the posture of the seat portion 31 from the flat posture to the chair posture, the extension and contraction drive unit 33a is driven and the tilt action of changing the posture of the seat portion 31 from the non-tilt posture to the tilt posture is performed at the same time. As a result, the posture of the seat portion 31 is changed in order of FIG. 13E, FIG. 13D, FIG. 13B, and FIG. 13A. That is, from the state of FIG. 13E in which the seat portion 31 is in the flat posture and the non-tilt posture, the reclining action is firstly started. After the reclining angle θr is increased to a predetermined angle (at-separation conjunction start angle θr2), the tilt action is started while continuing the reclining action, so that the posture is changed from the non-tilt posture to the tilt posture. By performing the two actions at the same time, the posture is changed from the state of FIG. 13D to the state of FIG. 13B (without going through the state of FIG. 13C). Therefore, after the tilt action is performed while the reclining angle θr of the chair back bottom member 31a is maintained to be a predetermined angle and the posture becomes the tilt posture, the posture of the seat portion 31 including the chair back bottom member 31a can be changed to the chair posture. As a result, steps of the actions are shortened more than in a case of separately performing the reclining action and the tilt action. In a case where the tilt action is performed after the reclining action, after performing the reclining action of the chair back bottom member 31a in order of FIG. 13E, FIG. 13C, FIG. 13B, and FIG. 13A and changing the posture from the flat posture to the chair posture, the tilt action from the non-tilt posture to the tilt posture is performed. By this tilt action, after the chair back bottom member 31a is once greatly raised as shown in FIG. 13C from the state of FIG. 13D, the chair back bottom member 31a is rotated to the flat posture side as shown in FIG. 13B, and the chair back bottom member 31a is unnecessarily inclined and moved. Thus, the burden may be imposed on the care-receiver. Meanwhile, in the first embodiment, by performing the reclining action and the tilt action at the same time, the tilt action is performed while the chair back bottom member 31a is maintained at a predetermined angle. Thus, the chair back bottom member 31a is prevented from being unnecessarily inclined and moved, so that the burden on the care-receiver can be reduced.

### Second Embodiment

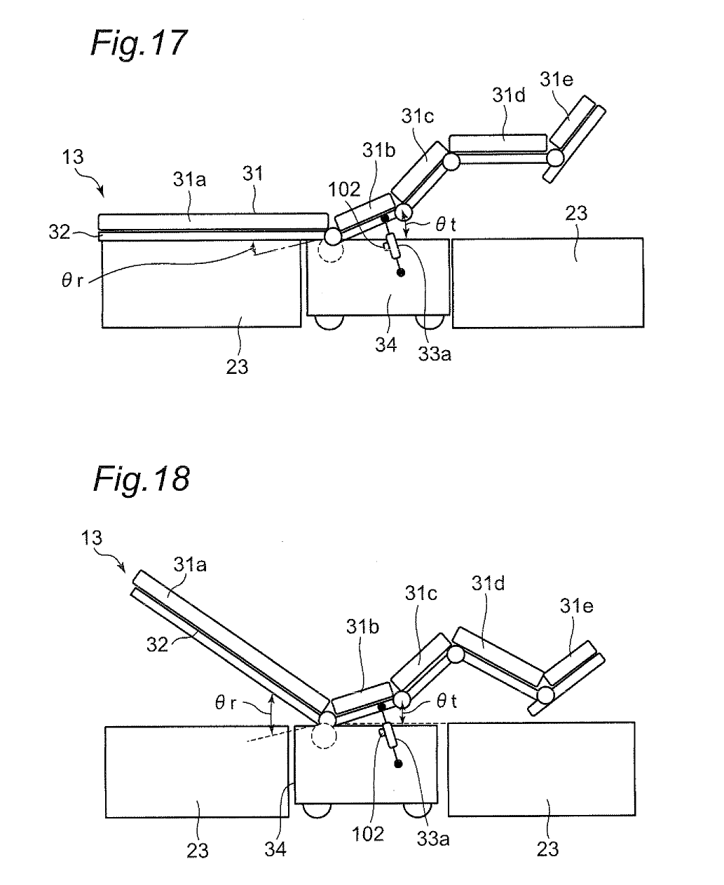

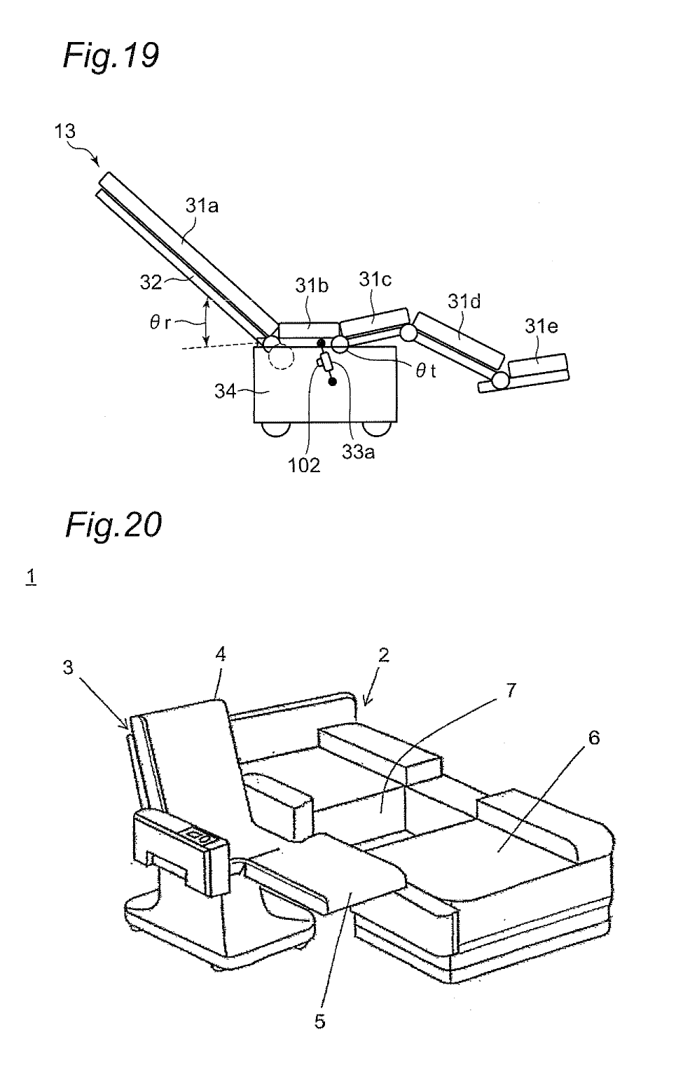

FIGS. 17, 18, and 19 are schematic side surfaces of the bed 11 showing a posture change of the seat portion 31 according to a second embodiment of the present invention.

Hereinafter, points in which the second embodiment is different from the first embodiment will be described with reference to the drawings.

A bed separation method according to the second embodiment is a method of actuating the seat guide mechanism unit 32 and the seat inclination mechanism unit 33 under the control of the control section 100 and the wheelchair control section 41 in such a manner that the chair back bottom member 31a is substantially horizontal until the chair waist bottom member 31b is raised at a predetermined angle at the time of changing the posture of the seat portion 31 from the non-tilt posture and the flat posture to the tilt posture.

That is, in the separating preparation step of separating the wheelchair 13 from the bed 11 shown in FIG. 10, the wheelchair 13 in the flat posture performs the tilt action and the reclining action at the same time. At the time, by performing control by the wheelchair control section 41 in such a manner that angle change speed by the tilt action and angle change speed by the reclining action are substantially the same, the chair waist bottom member 31b is inclined while the chair back bottom member 31a is maintained in a horizontal state as shown in FIG. 17. Thereby, after the tilt action reaches a target value, only the reclining action is continued. In a state where the chair waist bottom member 31b is inclined, the chair back bottom member 31a is inclined relatively to the chair waist bottom member 31b, so that the posture is changed to the tilt posture shown in FIG. 18.

In such a way, by raising the chair waist bottom member 31b in a state where the chair back bottom member 31a serves as a horizontal surface, when the chair back bottom member 31a is raised and the weight of the care-receiver supported by the chair back bottom member 31a is moved to the chair waist bottom member 31b, the movement can be performed in a state where the chair waist bottom member 31b is greatly bent with respect to the chair back bottom member 31a.

Thereby, when the chair back bottom member 31a is raised in a state where the reclining angle θr is larger than a predetermined angle, by the weight of the care-receiver supported by the chair back bottom member 31a, the body of the care-receiver can be prevented from slipping in the direction of the second chair leg bottom member 31e from the seat portion 31.

It should be noted that at the time of changing the posture of the seat portion 31 from the flat posture to the tilt posture, the tilt action and the reclining action may be performed at the same time after the reclining action is slightly performed and the reclining angle θr becomes about 5°. In a case where the angle change speed by the tilt action is faster than the angle change speed by the reclining action, at the time of performing the tilt action and the reclining action at the same time, the chair back bottom member 31a can be prevented from being lower than the horizontal plane (a head part of the care-receiver can be prevented from being lower than the horizontal plane).

With the bed separation method of the second embodiment, as described above, even when the chair back bottom member 31a is raised in the separating preparation step, the body of the care-receiver is not displaced. As a result, at the time of deforming from the wheelchair 13 to the bed 11, the burden on the body of the care-receiver can be reduced.

It should be noted that although the bed separation method is described in the second embodiment, the method can also be applied to the bed combination method. That is, in the bed formation step, by performing the reclining action until the chair back bottom member 31a is brought into a substantially flat posture, then controlling the speed in such a manner that an angle change by the tilt action and an angle change by the reclining action are substantially the same, and performing the tilt action and the reclining action at the same time, the posture of the seat portion 31 can be changed to the flat posture while the chair back bottom member 31a is maintained to be substantially horizontal.

It should be noted that timing at which the tilt action and the reclining action are performed at the same time is determined by detecting that the chair back bottom member 31a is substantially horizontal in the flat posture by the flat posture detection sensor 103. This timing may be determined by monitoring a reclining-only action time from the tilt posture by a timer.

By properly combining the arbitrary embodiment(s) or modification(s) of the aforementioned various embodiments and modifications, the effects possessed by the embodiment(s) or modification(s) can be produced.

Although the present invention has been fully described in connection with the preferred embodiments thereof with reference to the accompanying drawings, it is to be noted that various changes and modifications are apparent to those skilled in the art. Such changes or modifications are to be understood as included within the scope of the present invention as defined by the appended claims unless they depart therefrom.

### INDUSTRIAL APPLICABILITY

Since the combination and the separation of the wheelchair and the bed main portion can be performed while reducing the burden on the body of the care-receiver with the bed combination method and the separation method of the present invention, the methods are useful in an ordinary house, a hospital facility, a nursing care facility, or the like where the care-receiver in need of care resides.

1-11. (canceled)

12. A bed combination method of combining a chair base portion of a wheelchair with a bed base portion of a bed main portion so as to form a bed,
the method comprising:
at a combining preparation position in a vicinity of the bed base portion of the bed main portion, causing a seat portion of the wheelchair to perform a tilt action with respect to the chair base portion in a state where the seat portion is in a chair posture with respect to the chair base portion, and changing a posture of the seat portion to a tilt posture where the seat portion is inclined in such a manner that a position of a footrest composing the seat portion of the wheelchair is higher than the bed base portion of the bed main portion;
after the wheelchair is combined with the bed base portion by moving the wheelchair in the tilt posture into a recess part of the bed base portion,
starting a tilt action of the seat portion with respect to the chair base portion after a reclining angle of a chair back bottom member decreased by pivoting the chair back bottom member with respect to the chair base portion becomes a predetermined angle; and
changing the posture of the seat portion of the wheelchair from the tilt posture by the tilt action in a state where the reclining angle of the chair back bottom member is maintained to be constant, and at same time, changing the posture of the seat portion from the chair posture to a flat posture.

13. The bed combination method according to claim 12, wherein
when the posture of the seat portion is changed from the tilt posture to the flat posture,
a seat guide mechanism unit that changes the posture of the seat portion with respect to the chair base portion, and a seat inclination mechanism unit that pivots the seat guide mechanism unit about a pivot point are driven at same time.

14. The bed combination method according to claim 13, wherein
the seat inclination mechanism unit that rotatably couples the seat guide mechanism unit is provided on a lower side between the chair back bottom member and a chair waist bottom member coupled adjacently to the chair back bottom member,
the method comprising:
rotating a rotation support portion of the seat inclination mechanism unit, thereby pivoting the seat guide mechanism unit with respect to the chair base portion.

15. The bed combination method according to claim 13, wherein
when the posture of the seat portion is changed from the tilt posture to the flat posture,
after only the chair back bottom member composing the seat portion is brought close to the flat posture, the seat guide mechanism unit and the seat inclination mechanism unit are moved at same time.

16. A bed separation method of separating a wheelchair from a bed formed by combining a chair base portion of the wheelchair with a recess part of a bed base portion of a bed main portion,
the method comprising:
changing a posture of a seat portion of the wheelchair stored in the recess part of the bed base portion of the bed main portion from a flat posture and a non-tilt posture to a tilt posture where a position of a footrest is higher than the bed base portion in a state of a chair posture;
before the wheelchair is separated from the bed base portion by moving the wheelchair in the tilt posture from the recess part of the bed base portion,
starting a tilt action of the seat portion with respect to the chair base portion after a reclining angle of a chair back bottom member increased by pivoting the chair back bottom member with respect to the chair base portion becomes a predetermined angle; and
changing the posture of the seat portion of the wheelchair to the tilt posture by the tilt action in a state where the reclining angle of the chair back bottom member is maintained to be constant, and at same time, changing the posture of the seat portion from the flat posture to the chair posture.

17. The bed combination method according to claim 16, wherein
the seat inclination mechanism unit that rotatably couples the seat guide mechanism unit is provided on a lower side between the chair back bottom member and a chair waist bottom member coupled adjacently to the chair back bottom member,
the method comprising:
rotating a rotation support portion of the seat inclination mechanism unit, thereby pivoting the seat guide mechanism unit with respect to the chair base portion.

18. The bed separation method according to claim 17, wherein
when the posture of the seat portion is changed from the flat posture to the tilt posture,
after the seat guide mechanism unit and the seat inclination mechanism unit are moved, at same time, bringing only the chair back bottom member composing the seat portion close to the flat posture.

19. The bed separation method according to claim 17, wherein
when the posture of the seat portion is changed from the flat posture to the tilt posture,
the method comprising:
after only the chair back bottom member composing the seat portion is brought close to the tilt posture, moving the seat guide mechanism unit and the seat inclination mechanism unit at same time.

20. The bed separation method according to claim 18, wherein
when the posture of the seat portion is changed from the flat posture to the tilt posture,
the method comprising:
after only the chair back bottom member composing the seat portion is brought close to the tilt posture, moving the seat guide mechanism unit and the seat inclination mechanism unit at same time.

21. A bed comprising:
a control unit that performs the bed combination method according to claim 12.

22. A bed comprising:
a control unit that performs the bed separation method according to claim 16.
